(19) United States
(12) Patent Application Publication
(10) Pub. No.: US 2012/0212161 A1
(43) Pub. Date: Aug. 23, 2012

(54) ELECTROMECHANICAL DEVICE, MOVABLE BODY, AND ROBOT

(75) Inventors: Kesatoshi TAKEUCHI, Shiojiri (JP); Takahiro AMARI, Shiojiri (JP)

(73) Assignee: SEIKO EPSON CORPORATION, Tokyo (JP)

(21) Appl. No.: 13/396,995

(22) Filed: Feb. 15, 2012

(30) Foreign Application Priority Data
Feb. 17, 2011 (JP) 2011-031617

(51) Int. Cl. H02P 3/14

(52) U.S. Cl. 318/376

(57) ABSTRACT

An electromechanical device includes a first drive member having a magnetic coil, a second drive member capable of moving relatively to the first drive member, and a control section adapted to drive the magnetic coil and to perform regeneration of energy from the magnetic coil when decelerating the second drive member, and the control section includes a first regeneration mode of setting a first regenerative interval centered on a zero crossing point of an induced voltage caused in the magnetic coil, and performing the regeneration.

### BACKGROUND

1. Technical Field

The present invention relates to a control technology for an electromechanical device such as an electric motor or a generator.

2. Related Art

As an electric motor, there is known, for example, an electric motor described in JP-A-2001-298982.

In the electric motor of the related art, if the voltage applied to the magnetic coil is lowered, the rotational frequency-torque line is shifted toward a lower torque, and a lower rotational frequency. In other words, the rotational frequency and the output torque are lowered. Therefore, in order to rotate the electric motor at a high torque and a high rotational frequency, it is required to keep the voltage applied to the magnetic coil at a high level. In particular, in the case of using the electric motor for a moving apparatus such as a vehicle, there arises a problem that since a high voltage is applied to the magnetic coil in order to rotate the electric motor in a high rotational frequency range, the power consumption of the electric motor increases. Further, in the case of using the electric motor for the moving apparatus and using it as a regenerative brake in deceleration, excessive braking causes a jerky movement in some cases. These problems are common to electric motors.

### SUMMARY

An advantage of the invention is to solve at least one of the problems described above to thereby achieve a smooth operation in the regeneration process of the electromechanical device.

### Application Example 1

This application example of the invention is directed to an electromechanical device, including a first drive member having a magnetic coil, a second drive member capable of moving relatively to the first drive member, and a control section adapted to drive the magnetic coil and to perform regeneration of energy from the magnetic coil when decelerating the second drive member, wherein the control section includes a first regeneration mode of setting a first regenerative interval centered on a zero crossing point of an induced voltage caused in the magnetic coil, and performing the regeneration.

According to this application example, the first regenerative interval centered on the zero crossing point of the induced voltage caused in the magnetic coil is set, and then the regeneration is performed. In this case, since the rate of change in the regenerative energy with respect to the amount of regenerative energy can be made roughly constant irrespective of the regenerative intervals, a smooth operation can be achieved in the regeneration process of the electromechanical device.

### Application Example 2

This application example of the invention is directed to the electromechanical device of the above application example, wherein the control section further includes a second regeneration mode of setting a second regenerative interval centered on a local maximum point of the induced voltage caused in the magnetic coil, and performing the regeneration, and sets widths of the first and second regenerative intervals so that an amount of energy regenerated in the first regeneration mode is one of equal to and smaller than an amount of energy regenerated in the second regeneration mode.

According to this application example, since the regeneration is performed in the first regenerative interval centered on the zero crossing points of the induced voltage caused in the magnetic coil when the amount of the regenerative energy is small, or the regeneration is performed in the second regenerative interval centered on the local maximum points of the induced voltage generated in the magnetic coil when the amount of the regenerative energy is large, the smooth operation can be achieved in the regeneration process of the electromechanical device.

### Application Example 3

This application example of the invention is directed to the electromechanical device of Application Example 2, wherein the control section performs the regeneration in the first regeneration mode if a width of one of the first and second regenerative intervals is one of equal to and smaller than a predetermined first value, and performs the regeneration in the second regeneration mode if a width of one of the first and second regenerative intervals is one of equal to and larger than a predetermined second value larger than the first value.

According to this application example, since the regeneration is performed in the first regenerative interval centered on the zero crossing points of the induced voltage caused in the magnetic coil when the regeneration period is short and the amount of the regenerative energy is small, or the regeneration is performed in the second regenerative interval centered on the local maximum points of the induced voltage generated in the magnetic coil when the regeneration period is long and the amount of the regenerative energy is large, the smooth operation can be achieved in the regeneration process of the electromechanical device.

### Application Example 4

This application example of the invention is directed to the electromechanical device of Application Example 3, wherein the control section performs switching from the second regeneration mode to the first regeneration mode in a process in which an amount of energy regenerated decreases, and sets the width of the first regenerative interval immediately after the switching to be larger than the width of the second regenerative interval immediately before the switching.

According to this application example, since when performing the switching from the second regeneration mode to the first regeneration mode, the variation in the regenerative energy between before and after the switching can be reduced, the smooth operation can be achieved in the regeneration process of the electromechanical device.

### Application Example 5

This application example of the invention is directed to the electromechanical device of Application example 3 or 4, wherein the control section performs switching from the first regeneration mode to the second regeneration mode in a process in which an amount of energy regenerated increases, and sets the width of the second regenerative interval immediately after the switching to be smaller than the width of the first regenerative interval immediately before the switching.

According to this application example, since when performing the switching from the first regeneration mode to the second regeneration mode, the variation in the regenerative energy between before and after the switching can be reduced, the smooth operation can be achieved in the regeneration process of the electromechanical device.

### Application Example 6

This application example of the invention is directed to the electromechanical device of Application Example 4 or 5, wherein when performing switching between the first regeneration mode and the second regeneration mode, the control section sets the width of one of the first and second regenerative intervals immediately after the switching so that the amount of energy regenerated takes the same value between before and after the switching.

According to this application example, since the switching between the first regeneration mode and the second regeneration mode is performed so that the amount of energy regenerated is the same between before and after the switching, the regenerative energy can be continuous between before and after the switching, and the smooth operation can be achieved in the regenerative process of the electromechanical device.

### Application Example 7

This application example of the invention is directed to a movable body including the electromechanical device of any of Application Examples 1 to 6.

### Application Example 8

This application example of the invention is directed to a robot including the electromechanical device of any of Application Examples 1 to 6.

The invention can be realized in a variety of forms such as a method of controlling an electromechanical device, a movable body, or a robot besides the electromechanical device.

### BRIEF DESCRIPTION OF THE DRAWINGS

The invention will be described with reference to the accompanying drawings, wherein like numbers reference like elements.

FIG. 1 is an explanatory diagram showing an electric motor according to a first embodiment of the invention.

FIGS. 2A and 2B are explanatory diagrams showing a configuration of a rotor.

FIGS. 3A through 3G are explanatory diagrams showing an induced voltage waveform, a control waveform, and a drive waveform of the electric motor.

FIGS. 4A through 4I are explanatory diagrams showing the induced voltage waveform, the control waveform, and the drive waveform of the electric motor with the duty ratio varied.

FIGS. 5A through 5G are explanatory diagrams showing the induced voltage waveform, the control waveform, and the drive waveform of the electric motor with the gain saturated.

FIGS. 6A, 6B (6B-1 through 6B-3), 6C (6C-1 through 6C-3), and 6D (6D-1 through 6D-3) are explanatory diagrams showing the induced voltage waveform, the control waveform, and the drive waveform of the electric motor with lead angle control performed.

FIG. 7 is an explanatory diagram showing a relationship between the lead angle and the rotational frequency.

FIG. 8 is an explanatory diagram showing a relationship between the lead angle and the current.

FIG. 9 is an explanatory diagram showing a relationship between the lead angle and the rotational frequency/the current.

FIGS. 10A through 10D are explanatory diagrams showing an operation table of the electric motor using the T-N characteristics.

FIG. 11 is an explanatory diagram showing an operation table of the electric motor using the T-N characteristics including the case in which the gain exceeds 100%.

FIG. 12 is an explanatory diagram showing a control circuit block of the electric motor according to the present embodiment.

FIG. 13 is an explanatory diagram showing an example of an internal configuration of a PWM control section.

FIG. 14 is a block diagram showing an example of an internal configuration of a PWM section (FIG. 13).

FIG. 15 is a timing chart showing an operation of the PWM section when the electric motor rotates in the normal direction.

FIG. 16 is a timing chart showing an operation of the PWM section when the electric motor rotates in the reverse direction.

FIGS. 17A and 17B are explanatory diagrams showing an internal configuration and an operation of an excitation interval setting section.

FIG. 18 is an explanatory diagram showing an operation and a timing chart of a signing section.

FIGS. 19A through 19C are explanatory diagrams showing a three-phase drive circuit and magnetic coils.

FIGS. 20A and 20B are explanatory diagrams showing ON/OFF of the drive signals and the operation of the magnetic coil.

FIG. 21 is an explanatory diagram showing the connection of the magnetic coils of each of the phases.

FIG. 22 is an explanatory diagram showing another configuration of the PWM control section in the case of performing the lead angle control.

FIG. 23 is a block diagram showing a configuration of the excitation interval setting section.

FIG. 24 is a timing chart showing an operation of the excitation interval setting section.

FIG. 25 is an explanatory diagram for explaining how the lead angle is increased.

FIG. 26 is a timing chart showing an operation of the excitation interval setting section.

FIG. 27 is a timing chart showing another example of the operation of the excitation interval setting section.

FIG. 28 is an explanatory diagram showing a second embodiment of the invention.

FIGS. 29AA through 29AI are explanatory diagrams showing a regeneration pattern of energy in the case in which the length of an active period of the WC control waveform is long in a third embodiment of the invention.

FIGS. 29BA through 29BI are explanatory diagrams showing a regeneration pattern of energy in the case in which the length of the active period of the WC control waveform is short in the third embodiment.

FIG. 30A is an explanatory diagram showing a variation of an EPWM value and a recovery ratio of the regenerative energy.

FIG. 30B is an explanatory diagram showing a variation of the EPWM value and the recovery ratio of the regenerative energy.

FIG. 30C is an explanatory diagram showing a variation of the EPWM value and the recovery ratio of the regenerative energy.

FIG. 30D is an explanatory diagram showing a variation of the EPWM value and the recovery ratio of the regenerative energy.

FIG. 31 is an explanatory diagram showing a railroad vehicle using an electric motor according to a modified example of the invention.

FIG. 32 is an explanatory diagram showing an electric bicycle (an electric power-assisted bicycle) as an example of a movable body using a electric motor/generator according to another modified example of the invention.

FIG. 33 is an explanatory diagram showing an example of a robot using an electric motor according to another modified example of the invention.

### DESCRIPTION OF EXEMPLARY EMBODIMENTS

### First Embodiment

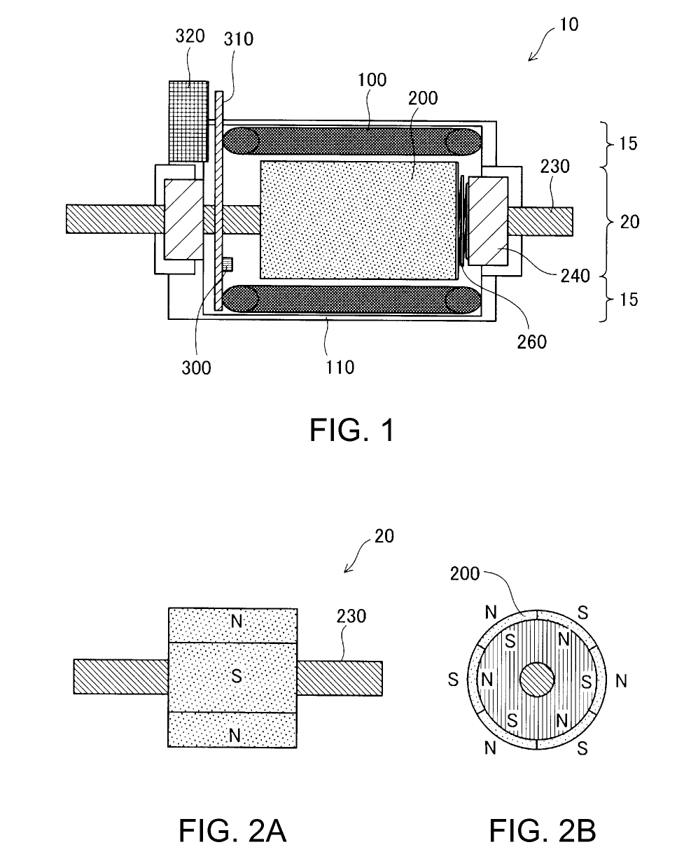

FIG. 1 is an explanatory diagram showing an electric motor according to a first embodiment. The electric motor 10 is an inner rotor motor having a radial gap structure in which a stator 15 having a roughly cylindrical shape disposed outside and a rotor 20 having a roughly cylindrical shape disposed inside. The stator 15 has a plurality of magnetic coils 100 arranged along the inner circumference of a casing 110. The stator 15 is further provided with a magnetic sensor 300 as a position sensor for detecting the phase of the rotor 20. The magnetic sensor 300 is installed at a position approximated to a waveform identical to the waveform normalized by the induced voltage generated by the magnetic coil 100 due to a permanent magnet 200 disposed on a rotary shaft 230, and is used as a position detector in the period of 0 through 2π in the electric angle. However, if the electric angle can be calculated using another encoder disposed on the rotary shaft 230, it becomes unnecessary to use the magnetic sensor 300. The magnetic sensor 300 is fixed on a circuit board 310, and the circuit board 310 is fixed to the casing 110. Further, the circuit board 310 is connected to an external control circuit by a connector 320.

The rotor 20 has the rotary shaft 230 at the center thereof, and the permanent magnet 220 disposed on the outer circumference thereof. The rotary shaft 230 is supported by a bearing 240 of the casing 110, and the bearing 240 is made of a nonconductive material. In the present embodiment, a coil spring 260 is disposed inside the casing 110. The coil spring 260 is used for positioning of the permanent magnet 200. It should be noted that the coil spring 260 can be eliminated.

FIGS. 2A and 2B are explanatory diagrams showing a configuration of the rotor. FIG. 2A shows a cross-sectional surface of the rotor cut by a plane parallel to the rotary shaft 230, and FIG. 2B shows a cross-sectional surface of the rotor cut by a plane perpendicular to the rotary shaft 230. The rotor 20 has six permanent magnets disposed on the periphery of the rotary shaft. Each of the permanent magnets 200 is magnetized along a radial direction (a radiation direction) from the center of the rotary shaft 230 toward the outside. Further, the permanent magnets 200 and the magnetic coil 100 are disposed so as to be opposed to a cylindrical surface where the rotor 20 and the stator 15 are opposed to each other.

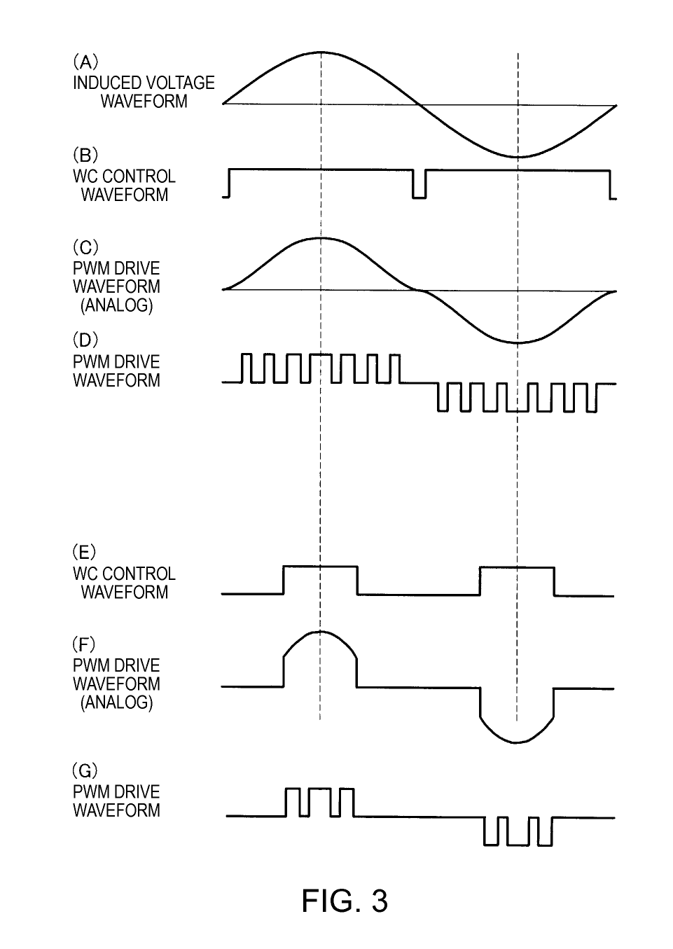

FIGS. 3A through 3G are explanatory diagrams showing an induced voltage waveform, a control waveform, and a drive waveform of the electric motor. FIG. 3A shows the induced voltage waveform of the electric motor 10. FIG. 3B shows an example of a WC control waveform used when driving the electric motor 10. FIG. 3C shows a PWM drive waveform (analog) applied to the electric motor 10 corresponding to the WC control waveform shown in FIG. 3B. FIG. 3D shows a PWM drive waveform (digital) applied to the electric motor 10 corresponding to the WC control waveform shown in FIG. 3B. As shown in FIG. 3A, the induced voltage waveform is a roughly sinusoidal wave. The term WC shown in FIG. 3B is an abbreviation of window comparator, and the WC control waveform is a signal waveform indicating the period (window) for exciting the magnetic coil 100 (FIG. 1) determined using a comparator. The center of the active period of the WC control waveform is the same as the phase at which the induced voltage waveform shown in FIG. 3A shows the maximum value. As shown in FIG. 3B, at the phase at which the induced voltage waveform shown in FIG. 3A becomes roughly zero, the WC control waveform is zero. Therefore, the analog PWM drive waveform shown in FIG. 3C becomes roughly zero at the phase at which the induced voltage waveform shown in FIG. 3A becomes roughly zero.

FIG. 3E shows a waveform obtained by narrowing the active period of the WC control waveform shown in FIG. 3B. FIG. 3F shows the PWM drive waveform (analog) applied to the electric motor 10 corresponding to the WC control waveform shown in FIG. 3E. FIG. 3G shows the PWM drive waveform (digital) applied to the electric motor 10 corresponding to the WC control waveform shown in FIG. 3E. The PWM drive waveform shown in FIG. 3F becomes zero when the WC control waveform is in the inactive state. Further, as is obvious from the comparison between FIGS. 3D and 3F, the shorter the active period of the WC control waveform is, the smaller the number of pulses becomes.

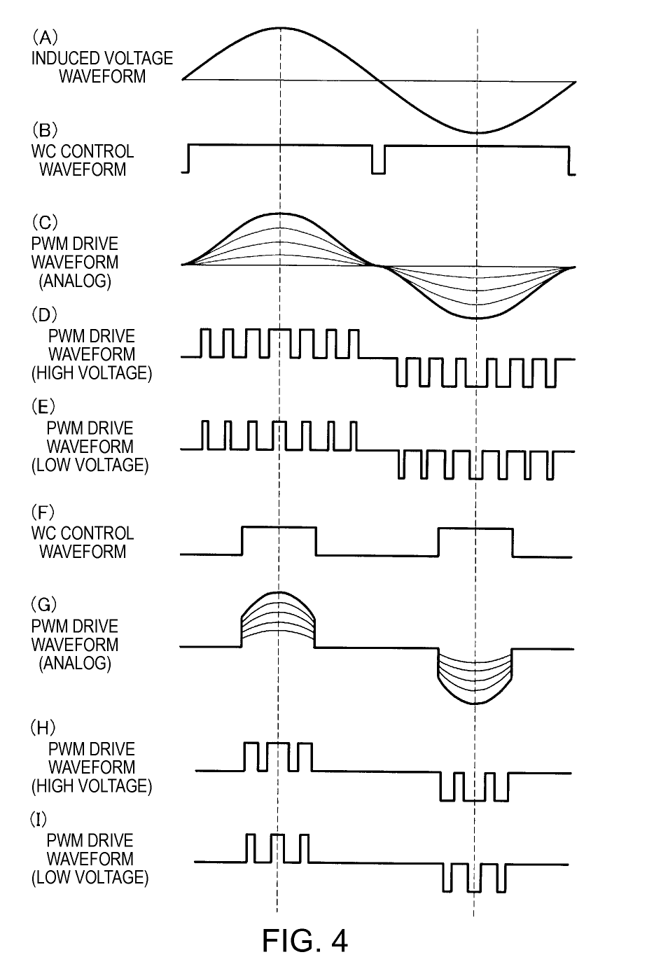

FIGS. 4A through 4I are explanatory diagrams showing the induced voltage waveform, the control waveform, and the drive waveform of the electric motor with the duty ratio varied. FIG. 4A shows the induced voltage waveform of the electric motor 10. FIG. 4B shows an example of the WC control waveform used when driving the electric motor 10. FIGS. 4A and 4B are identical to FIGS. 3A and 3B, respectively. FIG. 4C shows the PWM drive waveforms (analog) applied to the electric motor 10 corresponding to the WC control waveform shown in FIG. 4B. Here, the heavy line represents the PWM drive waveform in the sinusoidal wave with the gain of 100%, and the thin lines each represent the PWM drive waveform corresponding to a duty ratio lower than the duty ratio of the sinusoidal wave with the gain lower than 100%. FIGS. 4D and 4E each show the PWM drive waveform (digital) corresponding respectively to the heavy line and one of the thin lines in FIG. 4C. As is understood from the comparison between FIGS. 4D and 4E, although the number of pulses indicative of the active period is the same between FIGS. 4D and 4E, the width of the pulse shown in FIG. 4E is narrower than that of the corresponding pulse shown in FIG. 4D. It should be noted that in the case of decreasing the duty ratio, a pulse with a width smaller than a certain value can be set to zero to thereby be eliminated. FIGS. 4F through 4I correspond respectively to FIGS. 4B through 4E, and is obtained by shortening the active period of the WC control waveform than that of FIGS. 4B through 4E.

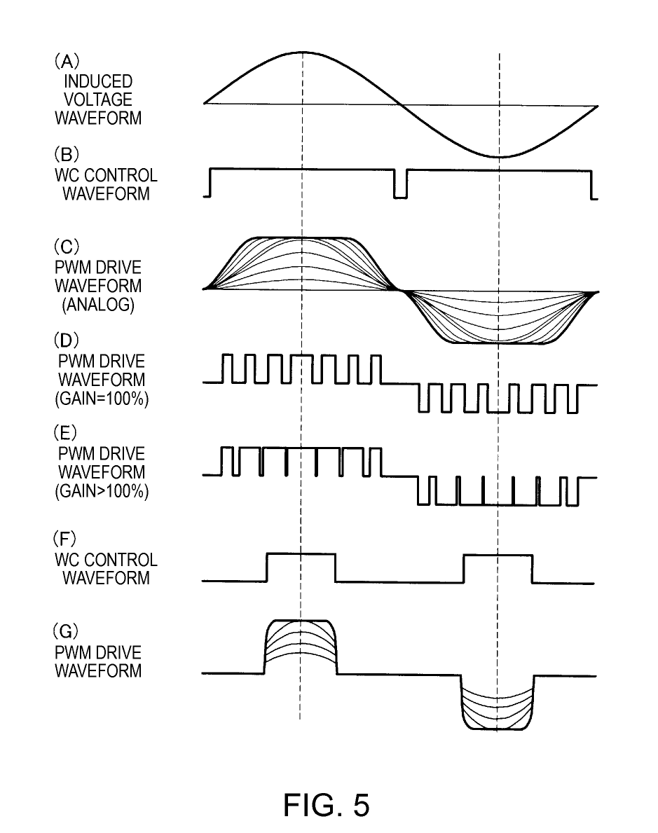

FIGS. 5A through 5G are explanatory diagrams showing the induced voltage waveform, the control waveform, and the drive waveform of the electric motor with the gain saturated. FIG. 5A shows the induced voltage waveform of the electric motor 10. FIG. 5B shows an example of the WC control waveform used when driving the electric motor 10. FIGS. 5A and 5B are identical to FIGS. 3A and 3B, respectively. The gain is an index number representing the length of the active period of the PWM drive. In the present embodiment, assuming that the induced voltage waveform from the magnetic coil 100 is a sinusoidal wave for the sake of convenience of explanation, it is defined that the value of (active period of the PWM drive signal)/(WC active period) in the case in which the PWM drive waveform is a sinusoidal wave corresponds to the gain of 100%. If the duty ratio is lowered beyond the duty ratio corresponding to the sinusoidal wave, the gain becomes smaller than 100%, and if the duty ratio is raised to be higher than the duty ratio corresponding to the sinusoidal wave, the gain exceeds 100%. If the gain exceeds 100%, the waveform approaches a rectangular waveform while being saturated. FIG. 5C shows the PWM drive waveforms (analog) corresponding respectively to various values of the gain. FIG. 5D shows the PWM drive waveform (digital) corresponding to the gain of 100%, and FIG. 5E shows the PWM drive waveform (digital) corresponding to the gain exceeding 100%. As is understood from the comparison between FIGS. 5D and 5E, although the number of pulses indicative of the active period is the same, the width of the pulse shown in FIG. 5E is larger than that of the corresponding pulse shown in FIG. 5D. Specifically, if the gain exceeds 100%, there is obtained a calculation result that the PWM drive waveform exceeds 100% around π/2 and 3π/2. However, since the maximum value of the gain is 100%, it results that the proportion of the area of 100% in the PWM drive waveform increases. FIG. 5F shows a waveform having an active period of the WC control waveform narrowed to be shorter than that of FIG. 5B. FIG. 5G shows a PWM drive waveform (analog) applied to the electric motor 10 corresponding to the WC control waveform shown in FIG. 5F. In FIG. 5G, the heavy line represents the case in which the gain exceeds 100%.

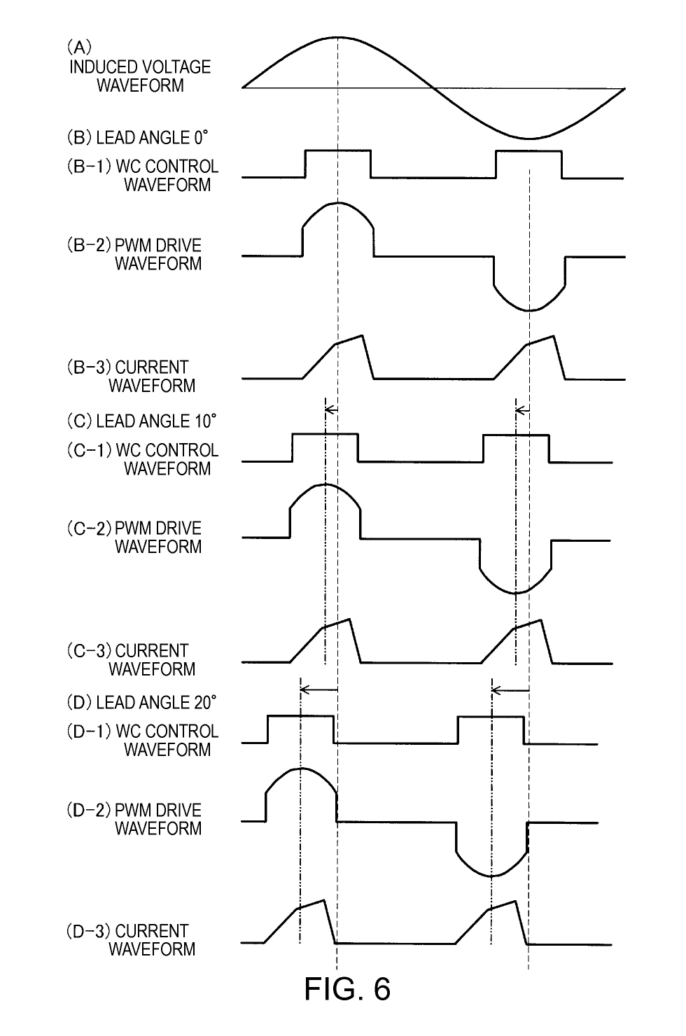

FIGS. 6A, 6B (6B-1 through 6B-3), 6C (6C-1 through 6C-3), and 6D (6D-1 through 6D-3) are explanatory diagrams showing the induced voltage waveform, the control waveform, and the drive waveform of the electric motor with lead angle control performed. Here, the width of the WC control waveform is narrowed as shown in FIGS. 3E, 4F, and 5F. FIG. 6A shows the induced voltage waveform of the electric motor 10. FIG. 6B-1 shows the WC control waveform with the lead angle of 0°, FIG. 6B-2 shows the PWM drive waveform with the lead angle of 0°, and FIG. 6B-3 shows a current waveform with the lead angle of 0°. FIGS. 6C (6C-1 through 6C-3) and 6D (6D-1 through 6D-3) similarly show the WC control waveform, the PWM drive waveform, and the current waveform at the lead angles of 10° and 20°, respectively. As described above, in the control of the electric motor 10, the control with the lead angle can be performed in addition to the control (first control) with the width of the WC control waveform and the control (second control) with the duty ratio.

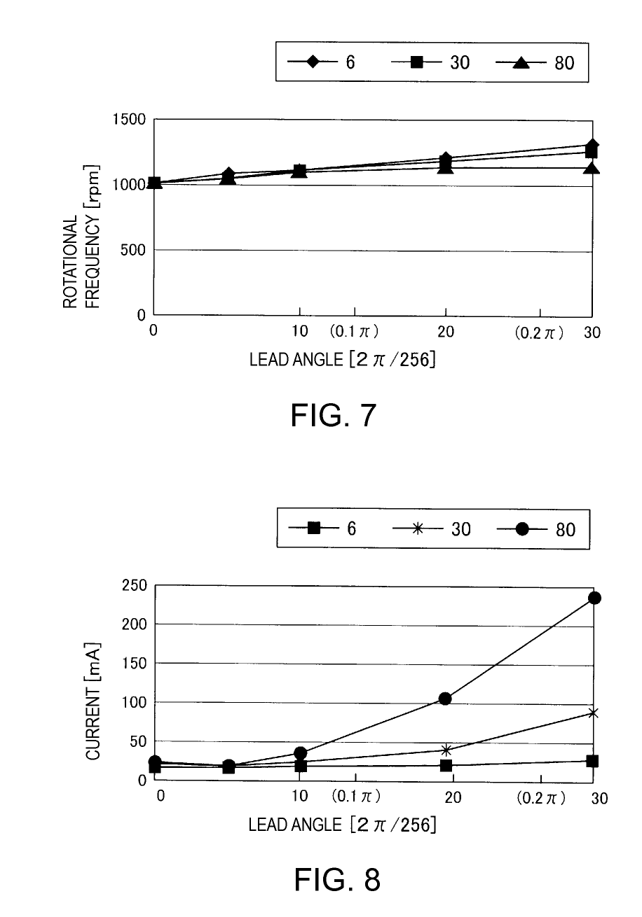

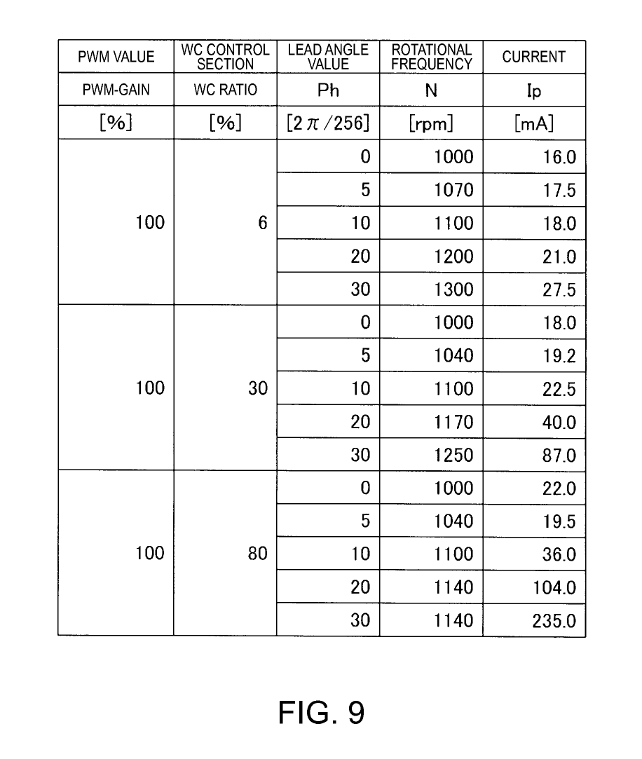

FIG. 7 is an explanatory diagram showing a relationship between the lead angle and the rotational frequency. FIG. 8 is an explanatory diagram showing a relationship between the lead angle and the current. FIG. 9 is an explanatory diagram showing a relationship between the lead angle and the rotational frequency/the current. FIGS. 7 and 8 are the graphs of the data shown in FIG. 9. In FIGS. 7 through 9, the WC control width takes three levels of 6%, 30%, and 80% assuming that the π period corresponds to 100% (constant drive). In each of the WC control widths, the duty ratio is adjusted so that the PWM drive waveform becomes a sinusoidal wave. Further, in each of the WC control widths, the PWM drive voltage is adjusted so that the rotational frequency of the electric motor 10 becomes 1,000 rpm at the lead angle of 0°.

As is understood from FIG. 7, the rotational frequency of the electric motor 10 rises as the lead angle is increased. The narrower the WC control width is, the more rapidly the rotational frequency rises. The reason therefor is that although in the case in which the WC control width is narrow, the lead angle increases with the phases causing the drive power hardly overlapping with each other before and after the increase in the lead angle, in the case in which the WC control width is large, large portions of the phases causing the drive power overlap with each other before and after the increase in the lead angle, and therefore, even if the lead angle is increased, the effect of the increase in the lead angle is difficult to appear. Further, as is understood from FIG. 8, in the case in which the WC control width is narrow, the rate of increase in the current in accordance with the increase in the lead angle is low. In contrast, in the case in which the WC control width is large, the current rapidly increases as the lead angle is increased. Therefore, if the WC control width is set to 6%, and the lead angle is increased, the rotational frequency of the electric motor 10 can be increased about 30% without substantially increasing the current. In other words, it becomes possible to rotate the electric motor 10 at high speed.

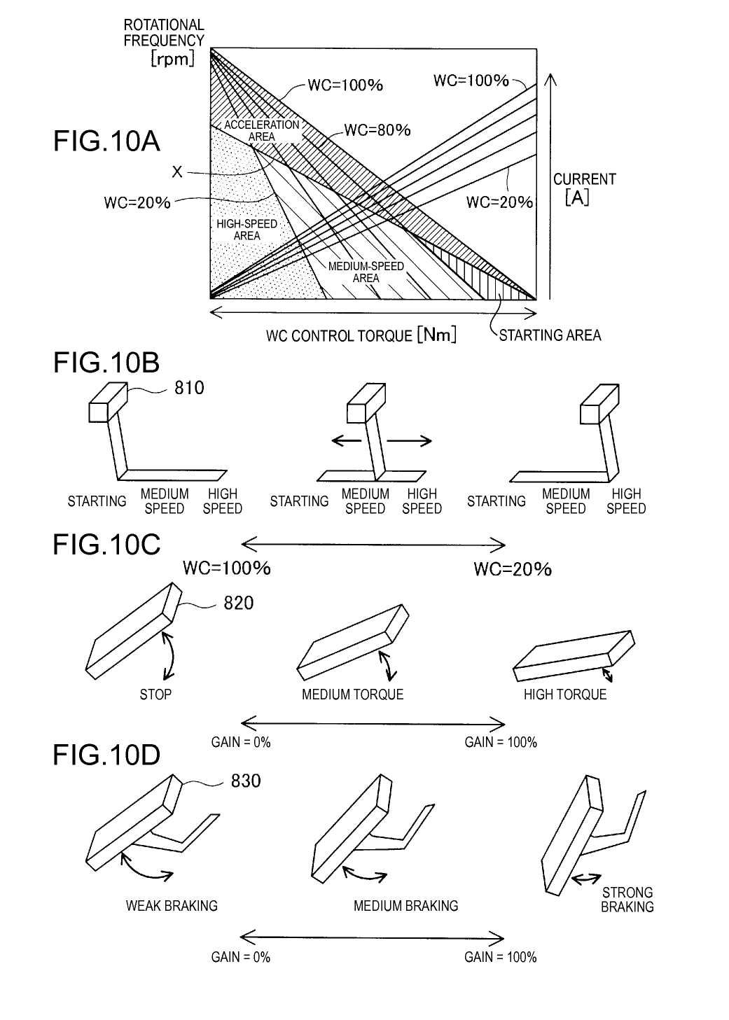

FIGS. 10A through 10D are explanatory diagrams showing an operation table of the electric motor using the T-N characteristics. The downward-sloping lines each represent a relationship between the torque and the rotational frequency. These straight lines represent the T-N characteristics corresponding to the WC control width from 100% to 20% by 20%. It should be noted that the gentlest downward-sloping straight line Xis a line for distinguishing the acceleration area from other areas, and does not represent the T-N characteristics. The area located on the left of the line corresponding to the WC control width of 20% is a high-speed area. Specifically, in the case in which the electric motor 10 is used in a movable body such as an electric vehicle or an electric train, it is an area used when the electric vehicle or the electric train moves at high speed. The area located on the right of the line corresponding to the WC control width of 20% and on the left of the line corresponding to the WC control width of 80% is a medium-speed area. The area located on the right of the line corresponding to the WC control width of 80% is a starting area (or a low-speed area). Independently of the high-speed area, the medium-speed area, and the low-speed area described above, the area on the upper side of the straight line X corresponds to an acceleration area. For example, the area located on the left of the line corresponding to the WC control width of 20% and on the upper side of the straight line X is a control area with high speed and for acceleration. The area located on the right of the line corresponding to the WC control width of 80% and on the lower side of the straight line X is a starting area. In general, if the electric vehicle or the electric train starts at the speed of 0 in this area, and then the speed rises (the rotational frequency rises), the transition to the acceleration area occurs.

The upward-sloping lines each represent a relationship between the torque and the current. Similarly to the T-N characteristics these straight lines represent the characteristics corresponding to the WC control width from 100% to 20% by 20%.

FIG. 10B shows a torque conversion operation lever 810 for switching between the high-speed area, the medium-speed area, and the starting area. The torque conversion operation lever 810 corresponds to a select lever in an automatic transmission car, or a shift lever in a stick shift car. For example, if the torque conversion operation lever 810 corresponds to the shift lever of the automatic transmission car, the starting position corresponds to a low range “L” or a first range “1,” the medium-speed position corresponds to a second range “S” or a second range “2,” and the high-speed position corresponds to a drive range “D.” It should be noted that since the stages of the automatic transmission is increasing, it is possible to regard that the medium-speed position corresponds to the drive range “D,” and the high-speed position corresponds to an overdrive (or an overtop) range “OD.”

FIG. 10C shows an accelerator pedal 820. The accelerator pedal 820 controls the duty ratio of the electric motor 10. Specifically, if the opening of the accelerator pedal 820 is large, the duty ratio (the gain) increases, and thus, the torque increases. Although the gain is set to 100% in the example shown in FIG. 10C, the gain exceeding 100% can be adopted.

FIG. 10D shows a brake pedal 830. The brake pedal is used in the case of braking the electric vehicle and the electric train. In the present embodiment, the brake pedal 830 and the duty ratio (the gain) coordinate with each other. Specifically, in the case (strong braking mode) in which the force on the brake pedal 830 is strong, the duty ratio is set to a high value to thereby regenerate more kinetic energy as electric energy. In contrast, in the case (weak braking mode) in which the force on the brake pedal 830 is weak, the duty ratio is set to a low value to thereby set the amount of regeneration of the kinetic energy to a small value. If the amount of regeneration of the kinetic energy in the case in which the force on the brake pedal is weak is set to a large value, the regenerative braking by the electric motor 10 acts too strongly, which might provide the driver with uncomfortable feeling.

It should be noted that it is also possible to perform the regeneration of the kinetic energy when braking while varying the WC control width by the torque conversion operation lever 810. In the case in which the torque conversion operation lever 810 is located at the starting position, it is also possible to increase the WC control width to thereby increase the amount of regeneration of the kinetic energy. On this occasion, it results that the regenerative braking becomes strong, namely, in the case of a vehicle, a strong engine brake acts thereon. In contrast, in the case in which the torque conversion operation lever 810 is located at the high-speed position, it is also possible to decrease the WC control width to thereby decrease the amount of regeneration of the kinetic energy. On this occasion, the regenerative braking hardly acts thereon.

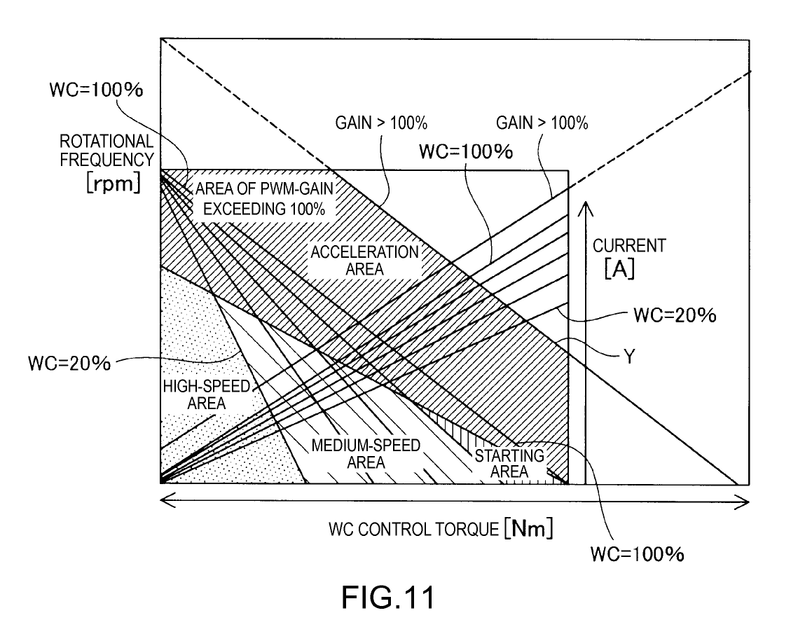

FIG. 11 is an explanatory diagram showing an operation table of the electric motor using the T-N characteristics including the case in which the gain exceeds 100%. In the present embodiment, it is arranged that the gain of 100% corresponds to the duty ratio at which the PWM drive waveform becomes a sinusoidal wave in the period of the WC control width. The state with the gain exceeding 100% denotes the state (the saturated state) in which the duty ratio is higher than the duty ratio corresponding to the sinusoidal wave in the period of the WC control width. The graph representing the T-N characteristics on this occasion shifts in an upper right direction. A straight line Y shown in FIG. 11 represents the T-N characteristics at the duty ratio of 100%. Since it is not achievable for the duty ratio to exceed 100%, the operation in the area on the upper right of the straight line Y is not achievable. The operating point corresponding to the gain exceeding 100% is located on the lower left of the straight line Y, and is located in the area on the upper right of the T-N characteristic line corresponding to the WC control width at that time, and is mainly included in the acceleration area.

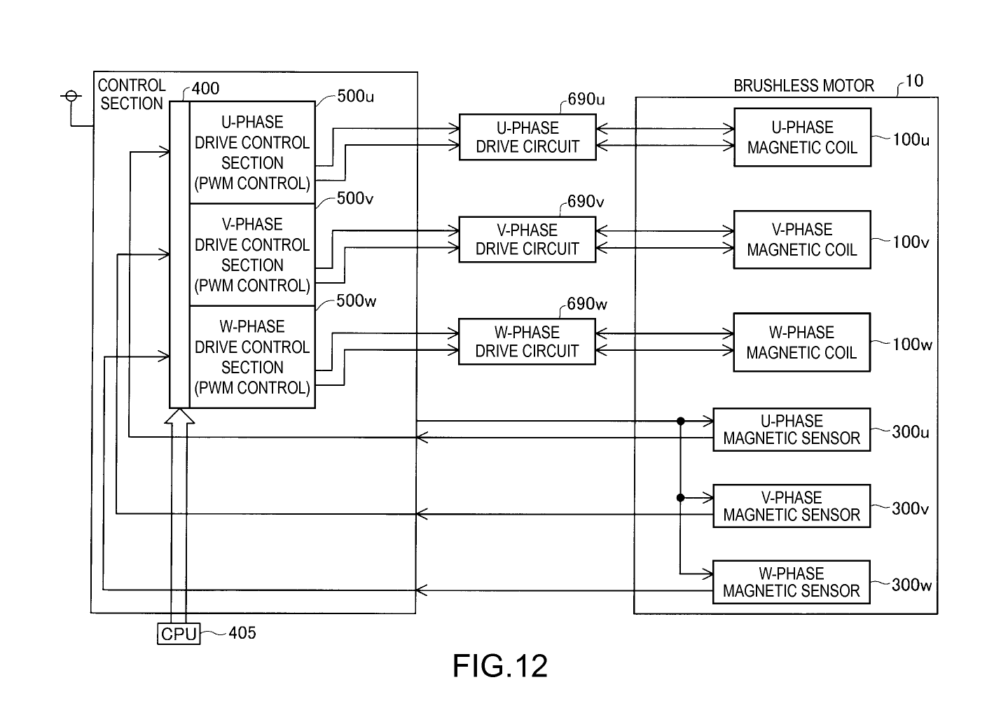

FIG. 12 is an explanatory diagram showing a control circuit block of the electric motor according to the present embodiment. Here, the explanation will be presented assuming that the electric motor 10 is a three-phase motor having the phases not connected using start connection or delta connection, but connected independently. The control circuit block is provided with a PWM control section 400, a CPU 405, a U-phase drive circuit 690u, a V-phase drive circuit 690v, and a W-phase drive circuit 690w. The PWM control section 400 includes a U-phase drive control section 500u, a V-phase drive control section 500v, and a W-phase drive control section 500w. The U-phase drive circuit 690u receives a control signal from the U-phase drive control section 500u, and then drives a U-phase magnetic coil 100u of a brushless motor (the electric motor) 10. The brushless motor 10 includes a U-phase sensor 300u, and the PWM control section 400 receives the position signal from the U-phase sensor 300u to perform the control. The control of the V-phase and the control of the W-phase are performed similarly.

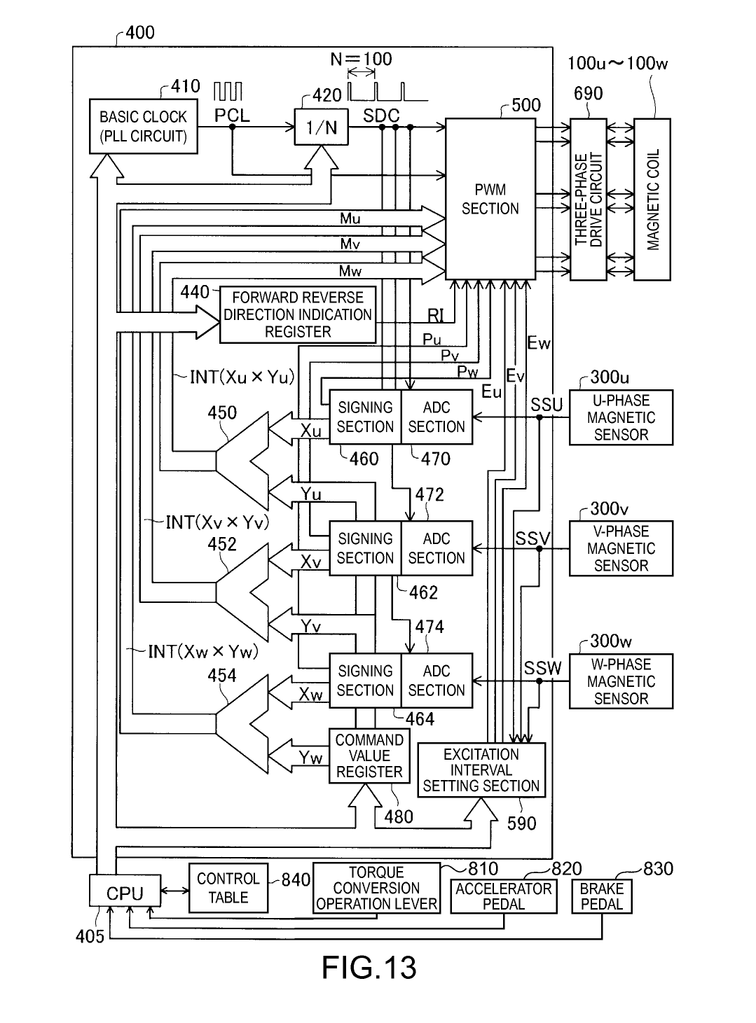

FIG. 13 is an explanatory diagram showing an example of an internal configuration of the PWM control section. The PWM control section 400 and the CPU 405 can also be disposed on the circuit board 310 (FIG. 1), or can also be disposed in an external circuit connected via the connector 320 (FIG. 1). The PWM control section 400 is provided with a basic clock generation circuit 410, a 1/N divider 420, a PWM section 500, a forward reverse direction indication value register 440, multipliers 450, 452, and 454, signing sections 460, 462, and 464, AD conversion sections (also referred to as ADC sections) 470, 472, and 474, a voltage command value register 480, and an excitation interval setting section 590. It should be noted that the U-phase drive control section 500u of the block diagram shown in FIG. 12 includes the multiplier 450, the signing section 460, the AD conversion section 470, and a control section related to the U-phase drive in the PWM section 500 in the explanatory diagram shown in FIG. 13. Substantially the same applies to the V-phase drive control section 500v and the W-phase drive control section 500w.

The basic clock generation circuit 410 is a circuit for generating a clock signal PCL having a predetermined frequency, and includes, for example, a PLL circuit. The divider 420 generates a clock signal SDC having the frequency 1/N of the frequency of the clock signal PCL. The value of N is set to a predetermined constant value. The value of N is set by the CPU 405 in advance in the divider 420. The PWM section 500 generates drive signals of the respective phases of u, v, and w in accordance with the clock signals PCL, SDC, multiplication values Mu, Mv, and Mw supplied from the multipliers 450, 452, and 454, a forward reverse direction indication value RI supplied from the forward reverse direction indication value register 440, positive/negative sign signals Pu, Pv, and Pw supplied from the signing sections 460, 462, and 464, and excitation interval signals Eu, Ev, and Ew supplied from the excitation interval setting section 590. This operation will be described later.

The forward reverse direction indication value RI indicating the rotational direction of the electric motor is set by the CPU 405 in the forward reverse direction indication value register 440. In the present embodiment, the electric motor rotates normally when the forward reverse direction indication value RI is in the L level, and reverses when it is in the H level.

Values of other signals Mu, Mv, Mw, Pu, Pv, Pw, Eu, Ev, and Ew supplied to the PWM section 500 are determined as follows. It should be noted that the multiplier 450, the signing section 460, and the AD conversion section 470 are circuits for the U phase, the multiplier 452, the signing section 462, and the AD conversion section 472 are circuits for the V phase, and the multiplier 454, the signing section 464, and the AD conversion section 474 are circuits for the W phase. It should be noted that since the operations of the circuit groups are the same, hereinafter the operation of the circuit group for the U phase will mainly be explained.

An output SSU of the magnetic sensor is supplied to the AD conversion section 470. The range of the sensor output SSU is, for example, from GND (the ground potential) to VDD (the power supply voltage), and the medium level point (=VDD/2) thereof corresponds to the medium level point (the point passing through the origin of a sinusoidal wave) of the output waveform. The AD conversion section 470 performs the AD conversion on the sensor output SSU to thereby generate the digitalized value of the sensor output. The range of the output of the AD conversion section 470 is, for example, FFh through Oh (the suffix “h” represents that the number is a hexadecimal number), and the central value on the positive side is set to 80h, and the central value 80h corresponds to the medium level point of the sensor waveform.

The signing section 460 converts the range of the sensor output value after the AD conversion, and at the same time sets the value of the medium level point of the sensor output value to zero. As a result, a sensor output value Xu generated by the signing section 460 takes a value in a predetermined range (e.g., +127 through 0) on the positive side or a predetermined range (e.g., 0 through −128) on the negative side. It should be noted that what is supplied from the signing section 460 to the multiplier 450 is the absolute value of the sensor output value Xu, and the positive/negative sign thereof is supplied to the PWM section 500 as the positive/negative sign signal Pu.

The voltage command value register 480 stores a voltage command value Yu set by the CPU 405. The voltage command value Yu functions as a value for setting the applied voltage of the electric motor together with the excitation interval signal Eu described later, and takes a value of, for example, 0 through 1.0. If the excitation interval signal Eu is set so as to set the entire interval to the excitation interval without providing a non-excitation interval, Yu=0 means that the applied voltage is set to zero, and Yu=1.0 means that the applied voltage is set to the maximum value. The multiplier 450 multiplies the sensor output value Xu output from the signing section 460 by the voltage command value Yu and then converts the result into an integer, and then supplies the PWM section 500 with the multiplication value Mu. The output of the PWM section 500 is input to the three-phase drive circuit 690, and then the magnetic coils 100u through 100w are driven.

Control signals from the torque conversion operation lever 810, the accelerator pedal 820, and the brake pedal 830 are input to the CPU 405. Further, a control table 840 is connected to the CPU 405. The CPU 405 refers to the control table 840 based on the control signals (tread amount) from the torque conversion operation lever 810, the accelerator pedal 820, and the brake pedal 830 to thereby determine the width and the amount of the lead angle of the excitation interval signal Eu, and then outputs the excitation interval signal Eu. The control table 840 is preferably set so that the narrower the width of the excitation interval signal Eu is, the more the lead angle of the excitation interval signal Eu is increased. It should be noted that the relationships between the tread amounts of the accelerator pedal 820 and the brake pedal 830 and the control amounts of the width and the lead angle amount of the excitation interval signal Eu are experimentally or empirically set in advance. It should be noted that it is also possible to set the control table 840 so that the either one of the width and the lead angle amount of the excitation interval signal Eu is adjusted.

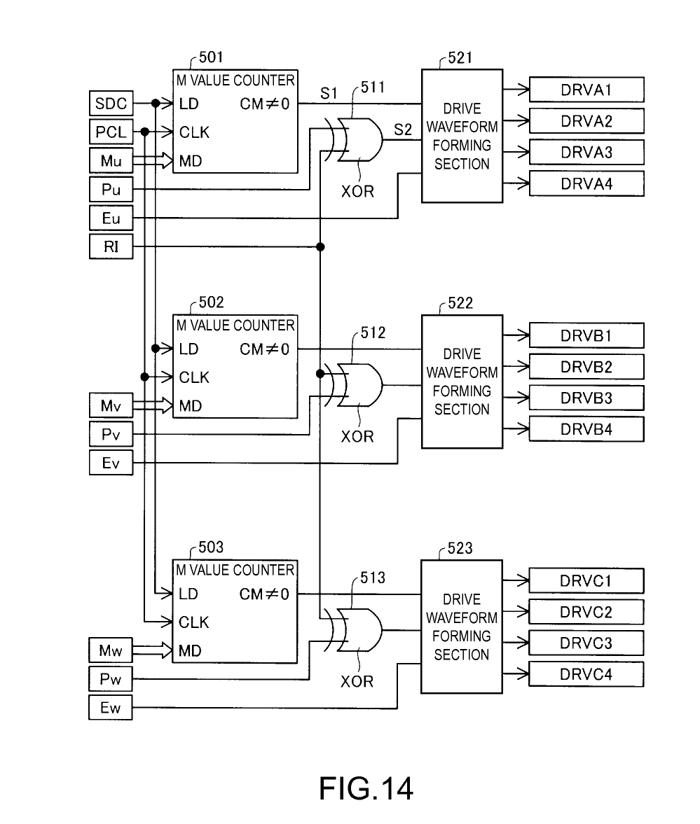

FIG. 14 is a block diagram showing an example of an internal configuration of the PWM section 500 (FIG. 13). The PWM section 500 is provided with counters 501, 502, and 503, EXOR circuits 511, 512, and 513, and drive waveform forming sections 521, 522, and 523. The counter 501, the EXOR circuit 511, and the drive waveform forming section 521 are the circuits for the U phase, the counter 502, the EXOR circuit 512, and the drive waveform forming section 522 are the circuits for the V phase, and the counter 503, the EXOR circuit 513, and the drive waveform forming section 523 are the circuits for the W phase. The operations of these circuits will be explained below with reference to timing charts.

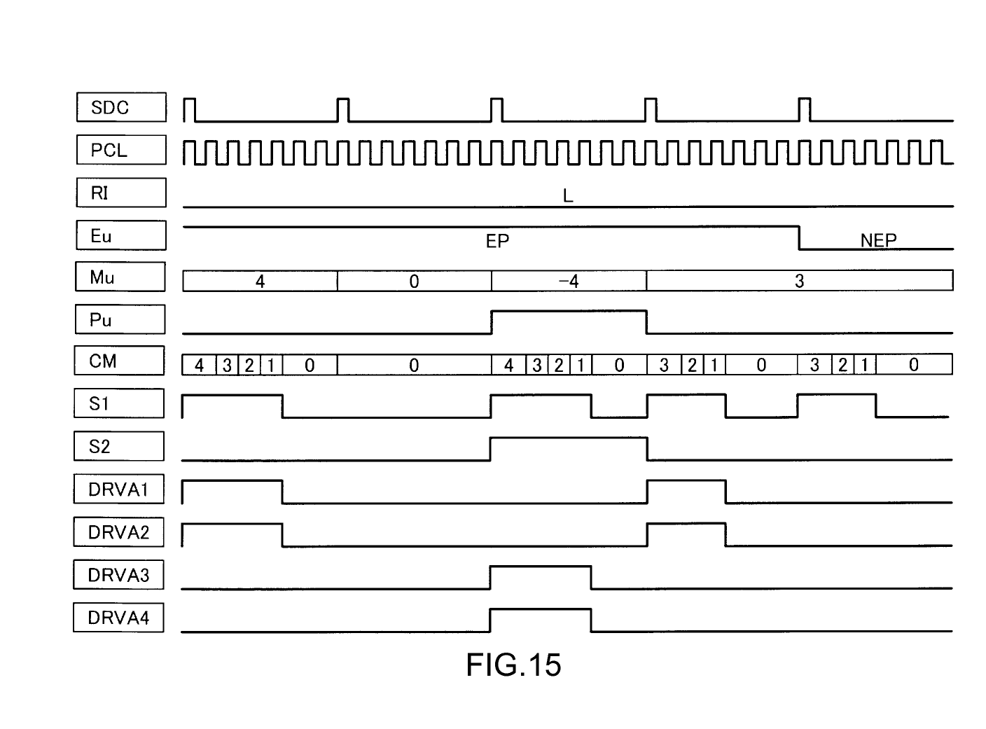

FIG. 15 is the timing chart showing the operation of the PWM section 500 when the electric motor rotates in the normal direction. Since the operations of the U phase, the V phase, and the W phase are identical to each other, the explanation will be presented here citing the U phase as an example. The drawing shows the two clock signals PCL, SDC, the forward reverse direction indication value RI, the excitation interval signal Eu, the multiplication value Mu, the positive/negative sign signal Pu, a count value CM1 in the counter 501, an output S1 of the counter 501, an output S2 of the EXOR circuit 511, and drive signals DRVA1 through DRVA4 from the drive waveform forming section 521. The counter 501 repeats the operation of counting down the count value CM1 to 0 in sync with the clock signal PCL in every period of the clock signal SDC. The initial value of the count value CM1 is set to be equal to the multiplication value Mu. It should be noted that although in FIG. 15 a negative value is described as the multiplication value Mu for the sake of convenience of illustration, the value used in the counter 501 is the absolute value |Mu| thereof. The output S1 of the counter 501 is set to the H level if the count value CM1 is not equal to 0, and falls to the L level when the count value CM1 becomes equal to 0.

The EXOR circuit 511 outputs the signal S2 representing the exclusive OR of the positive/negative sign signal Pu and the forward reverse direction indication value RI. When the electric motor rotates in the normal direction, the forward reverse direction indication value RI is in the L level. Therefore, the output S2 of the EXOR circuit 511 becomes a signal identical to the positive/negative sign signal Pu. The drive waveform forming section 521 generates the drive signals DRVA1 through DRVA4 based on the output S1 of the counter 501 and the output S2 of the EXOR circuit 511. Specifically, out of the output S1 of the counter 501, the signal in the period in which the output S2 of the EXOR circuit 511 is in the L level is output as the first and second drive signals DRVA1, DRVA2, and the signal in the period in which the output S2 is in the H level is output as the third and fourth drive signals DRVA3, DRVA4. It should be noted that in the vicinity of the right end of FIG. 15, the excitation interval signal Eu falls to the L level, and a non-excitation interval NEP is set in response thereto. Therefore, in the non-excitation interval NEP, neither of the drive signals DRVA1 through DRVA4 is output, and the high-impedance state is maintained.

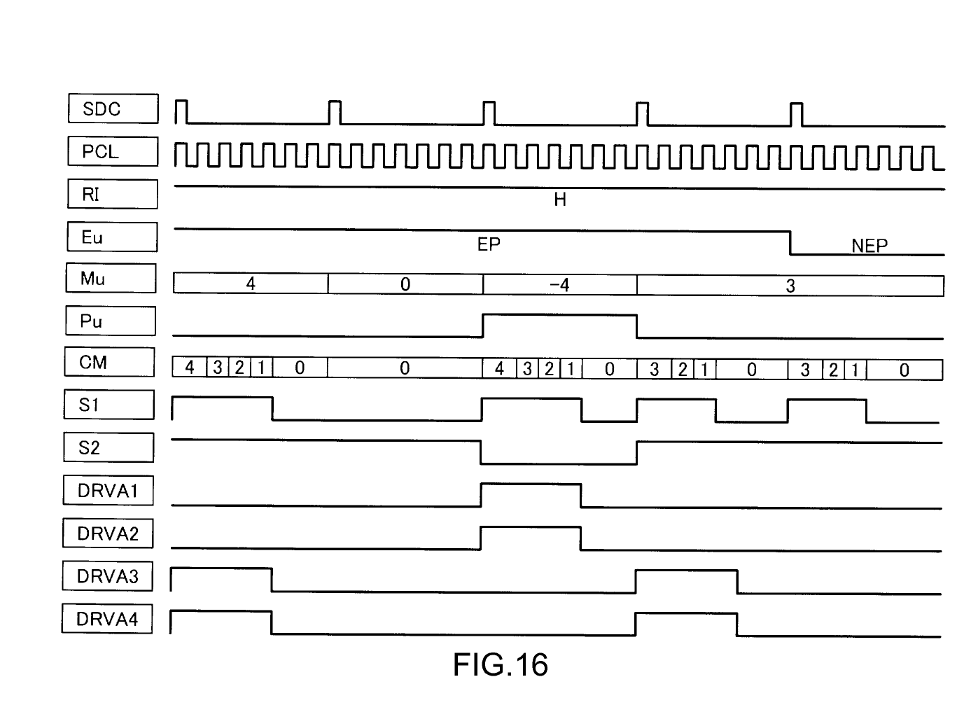

FIG. 16 is the timing chart showing the operation of the PWM section 500 when the electric motor rotates in the reverse direction. When the electric motor rotates in the reverse direction, the forward reverse direction indication value RI is set to the H level. As a result, the first and second drive signals DRVA1, DRVA2 and the third and fourth drive signals DRVA3, DRVA4 are replaced with each other compared to the case shown in FIG. 15, and as a result, it is understood that the electric motor rotates in the reverse direction. It should be noted that substantially the same operation is performed on the circuits 502, 512, and 522 for the V phase and the circuits 503, 513, and 523 for the W phase of the PWM section 500.

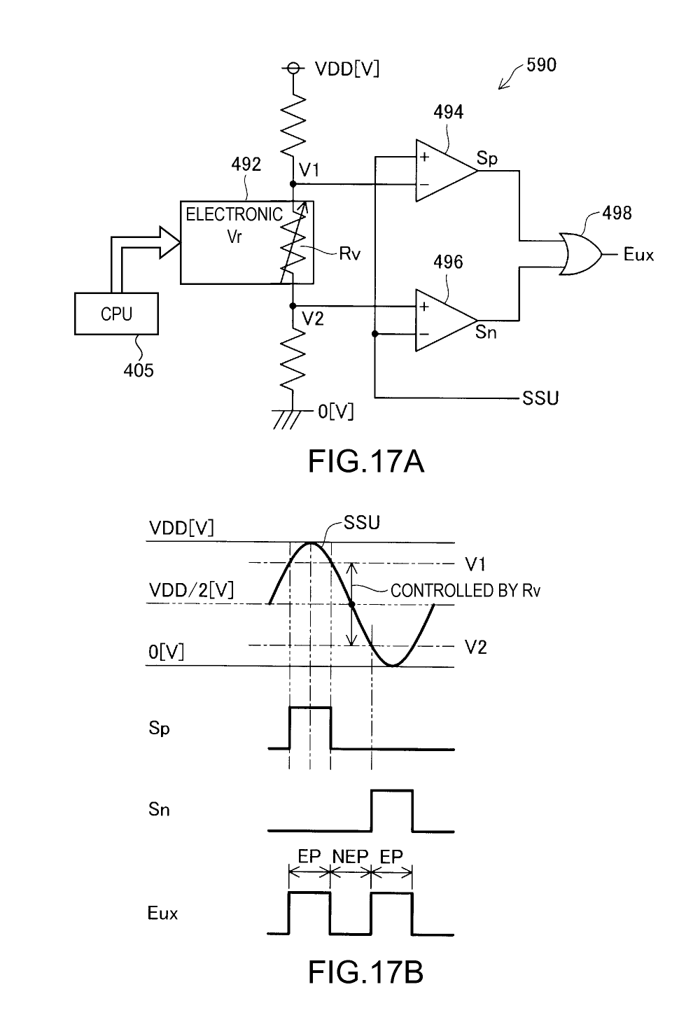

FIGS. 17A and 17B are explanatory diagrams showing an internal configuration and an operation of the excitation interval setting section 590. The excitation interval setting section 590 has an electronic variable resistor 492, voltage comparators 494, 496, and an OR circuit 498. The resistance value Rv of the electronic variable resistor 492 is set by the CPU 405. The voltages V1, V2 of the both ends of the electronic variable resistor 492 are provided respectively to one input terminals of the voltage comparators 494, 496. The other input terminal of the voltage comparators 494, 496 are supplied with the sensor output SSU. It should be noted that the circuits for the V phase and the W phase are omitted in FIGS. 17A and 17B for the sake of convenience. Output signals Sp, Sn of the voltage comparators 494, 496 are input to the OR circuit 498. The output of the OR circuit 498 is an excitation interval signal Eux for distinguishing between the excitation interval and the non-excitation interval. The excitation interval signal Eux is fed to the CPU 405, and the CPU 405 refers to the control table 840 based on the length of the excitation interval signal Eux, and the control signals from the torque conversion operation lever 810, the accelerator pedal 820, and the brake pedal 830 to thereby determine the lead angle of the excitation interval signal Eu (see FIG. 13). It should be noted that if the lead angle is not increased, the excitation interval signals Eu, Eux are identical to each other.

FIG. 17B shows an operation of the excitation interval setting section 590. The voltages V1, V2 of the both ends of the electronic variable resistor 492 are varied by controlling the resistance value Rv. Specifically, the voltages V1, V2 of the both ends are set to values having the same difference from the center value (=VDD/2) of the voltage range. If the sensor output SSU is higher than the first voltage V1, the output Sp of the first voltage comparator 494 becomes in the H level, and in contrast, if the sensor output SSU is lower than the second voltage V2, the output Sn of the second voltage comparator 496 becomes in the H level. The excitation interval signal Eux is a signal obtained by performing logical addition on these output signals Sp, Sn. Therefore, as shown in the lower part of FIG. 17B, the excitation interval signal Eux can be used as a signal indicating the excitation interval EP and the non-excitation interval NEP. The setting of the excitation interval EP and the non-excitation interval NEP is performed by the CPU 405 controlling the variable resistance value Rv.

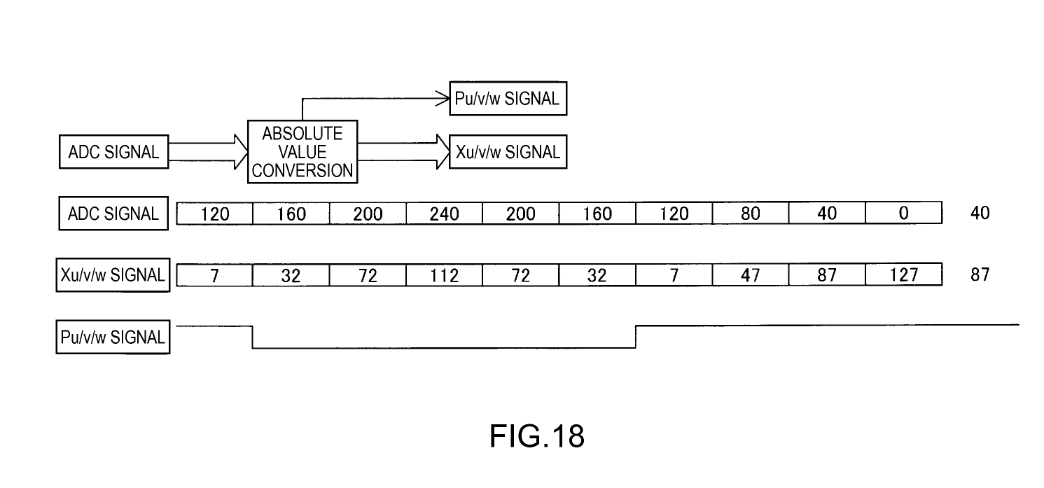

FIG. 18 is an explanatory diagram showing an operation and a timing chart of the signing section. Here, the explanation will be presented citing the signing section 460 (FIG. 13) for the U phase as an example. The signing section 460 receives an ADC signal from the ADC section 470 (FIG. 13), and then generates the sensor output value Xu and the positive/negative sign signal Pu. Here, the sensor output value Xu is a value obtained by shifting the ADC signal to the range of +127 through −128 and then calculating the absolute value thereof. Further, the positive/negative sign signal Pu is set to the H level if the value of the ADC signal is smaller than 0, or to the L level if the value of the ADC signal is greater than 0. It should be noted that the sign of the positive/negative sign signal Pu can be reversed.

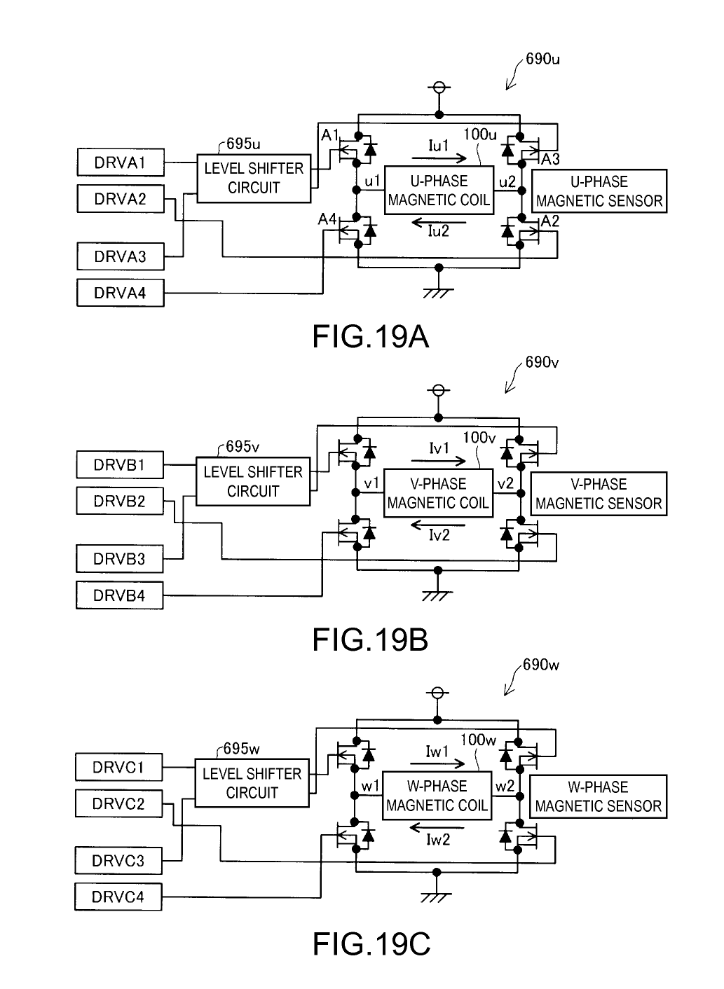

FIGS. 19A through 19C are explanatory diagrams showing the three-phase drive circuit and the magnetic coils. The three-phase drive circuit 690 is provided with the U-phase drive circuit 690u, the V-phase drive circuit 690v, and the W-phase drive circuit 690w. Since the drive circuits 690u, 690v, and 690w have the same configuration, the explanation will be presented citing the U-phase drive circuit 690u as an example. The U-phase drive circuit 690u is an H-bridge circuit, and drives the U-phase magnetic coil 100u in accordance with the drive signals DRVA1 through DRVA4. It should be noted that in the present embodiment a level shifter circuit 695u is connected to the gate of each of transistors A1, A3 connected to the power supply side. The level shifter circuit 695u is used for raising the gate potential in the transistors A1, A3 to be higher than the power supply potential VS. Even if the transistor A1 is switched ON, the potential of a terminal u1 can only rise to (gate voltage)−(threshold level of the transistor A1). Therefore, if the gate potential is equal to the potential of the drain, so-called threshold drop occurs. If the gate potential of the transistor A1 is raised to be higher than (power supply potential VS)+(threshold level of the transistor A1) using the level shifter circuit 695u, it becomes possible to raise the potential of the terminal u1 to the power supply voltage VS when switching ON the transistor A1. It should be noted that the level shifter circuit 695u can be eliminated. Further, in the case in which a P-channel transistor is used as the transistor A1, the level shifter circuit 695u can be eliminated. The same can be applied to the transistor A3. An arrow denoted by a symbol Iu1 indicates the direction of a current flowing through the magnetic coil 100u when the drive signals DRVA1, DRVA2 are in an ON level, and an arrow denoted by a symbol Iu2 indicates the direction of a current flowing through the magnetic coil 100u when the drive signals DRVA3, DRVA4 are in the ON level. Substantially the same applies to the V-phase drive circuit 690v and the W-phase drive circuit 690w.

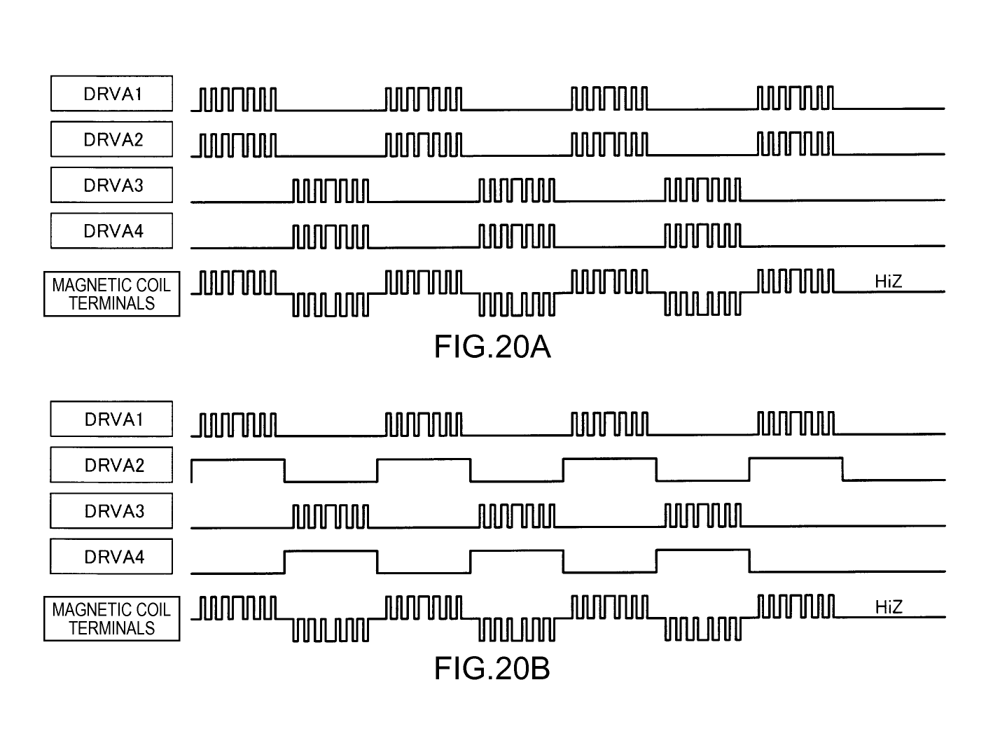

FIGS. 20A and 20B are explanatory diagrams showing ON/OFF of the drive signals and the operation of the magnetic coil. Here, the explanation will be presented citing the U phase as an example. Substantially the same applies to the V-phase and the W-phase. In the example shown in FIG. 20A, the drive signals DRVA1, DRVA2 are sync with each other, and the drive signals DRVA3, DRVA4 are sync with each other. In the period in which the drive signals DRVA1, DRVA2 are switched to the ON level, a current flows through the magnetic coil 100u in a positive direction (the direction of the symbol Iu1 shown in FIG. 19A). In the period in which the drive signals DRVA3, DRVA4 are switched to the ON level, a current flows through the magnetic coil 100u in a negative direction (the direction of the symbol Iu2 shown in FIG. 19A). It should be noted that in the period in which the drive signals DRVA1 through DRVA4 are in an OFF level, the high-impedance (HiZ) state is set.

In contrast, in an example shown in FIG. 20B, the drive signal DRVA2 is kept ON in the period in which the drive signal DRVA1 is switched to the ON level, and the drive signal DRVA4 is kept ON in the period in which the drive signal DRVA3 is switched to the ON level. Similarly, in this case, in the period in which both of the drive signals DRVA1, DRVA2 are switched to the ON level, a current flows through the magnetic coil 100u in the positive direction (the direction of the symbol Iu1 shown in FIG. 19A). In the period in which both of the drive signals DRVA3, DRVA4 are switched to the ON level, a current flows through the magnetic coil 100u in the negative direction (the direction of the symbol Iu2 shown in FIG. 19A). Incidentally, if the drive signals DRVA2, RDVA4 for driving transistors A2, A4 on the ground side are kept in the ON level in the period as described above, it becomes possible to flow the current due to the induced electromotive force caused by the magnetic coil section thus excited even in the period in which the transistors A1, A3 are in the OFF state, and an advantage that the torque can be increased can be obtained.

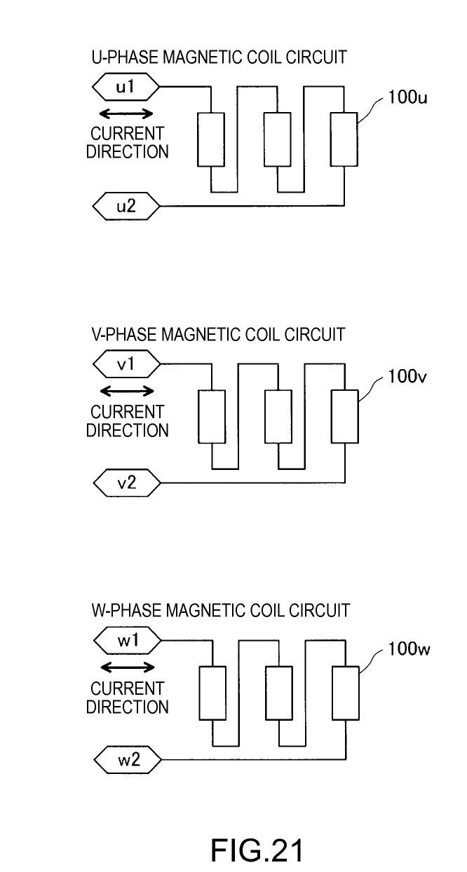

FIG. 21 is an explanatory diagram showing the connection of the magnetic coils of each of the phases. In the present embodiment, each of the phases includes a plurality of magnetic coils 100u (100v or 100w). The magnetic coils 100u (100v or 100w) are connected in series in each of the phases. By connecting the magnetic coils in series, it becomes possible to reduce the current. It should be noted that the magnetic coils 100u (100v or 100w) can also be connected in parallel to each other. By connecting the magnetic coils in parallel to each other, it is possible to increase the voltage applied to each of the coils 100u (100v or 100w) to thereby increase the output.

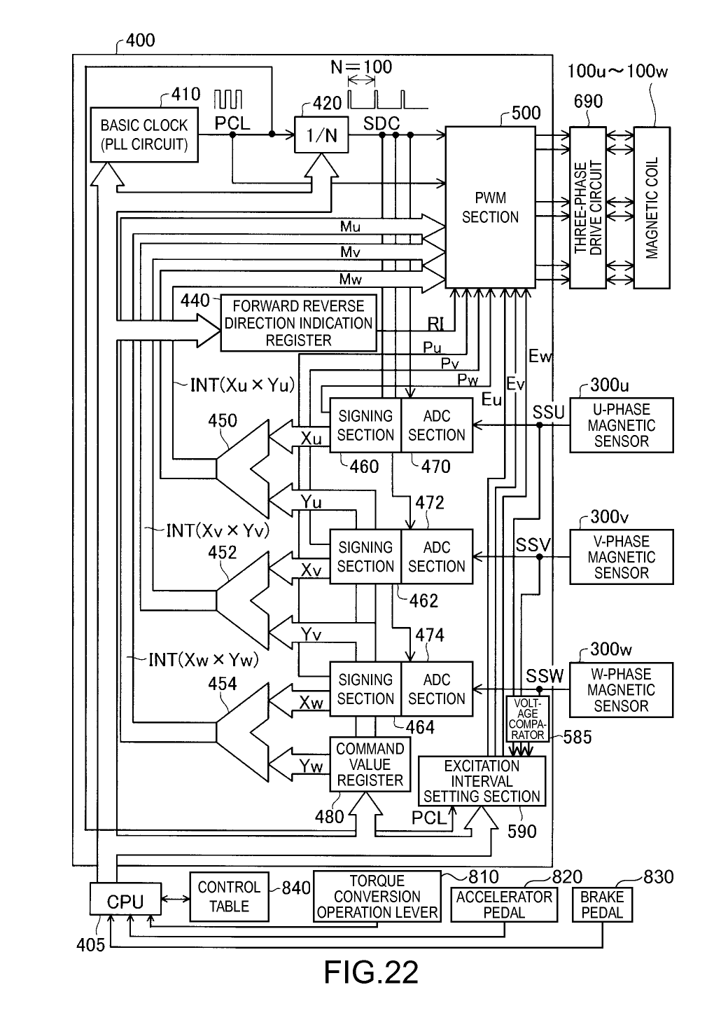

FIG. 22 is an explanatory diagram showing another configuration of the PWM control section in the case of performing the lead angle control. The configuration shown in FIG. 22 is roughly the same as the configuration shown in FIG. 13, but is different therefrom in the point that the internal configuration of the excitation interval setting section 590 is different as described later, the point that a voltage comparator 585 is disposed between the position sensors 300u, 300v, and 300w and the excitation interval setting section 590, and the point that the clock signal PCL is input to the excitation interval setting section 590. The voltage comparator 585 performs the voltage comparison in the electric angle range from 0 to 2π to thereby detect the period corresponding to 0 through π and the period corresponding to π through 2π, and then outputs a polarity signal SC.

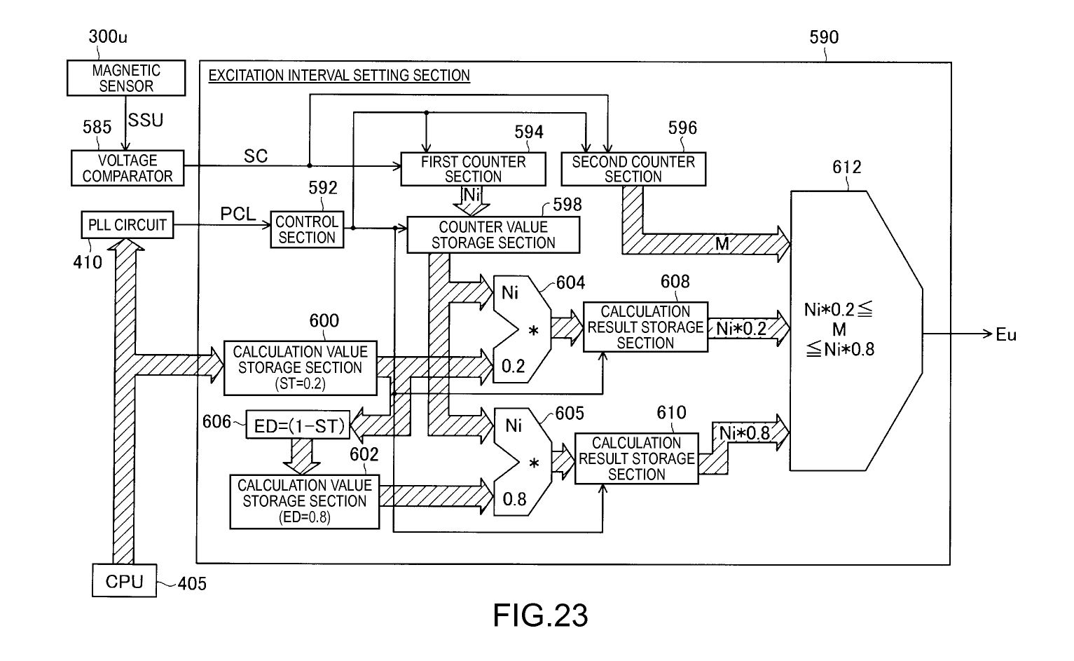

FIG. 23 is a block diagram showing a configuration of the excitation interval setting section 590. FIG. 23 shows the magnetic sensor 300u, the voltage comparator 585, a PLL circuit 510, and the CPU 405 besides the excitation interval setting section 590. It should be noted that although the explanation will be presented here citing the U phase as an example, substantially the same applies to the V phase and the W phase. The excitation interval setting section 590 is provided with a control section 592, a first counter section 594, a second counter section 596, a counter value storage section 598, and two calculation value storage sections 600, 602. The excitation interval setting section 590 is further provided with two multiplication circuits 604, 605, a calculation circuit 606, two calculation result storage sections 608, 610, and a comparator circuit 612. The PLL circuit 510 generates the clock signal PCL used in the excitation interval setting section 590. The control section 592 supplies the counter sections 594, 596 with the clock signal PCL, and at the same time, supplies the counter value storage section 598 and the calculation result storage sections 608, 610 with an appropriate holding timing (latch timing). These constituents operate as follows. It should be noted that firstly the case in which the lead ingle is not increased will be explained, and then the case of increasing the lead angle will be explained.

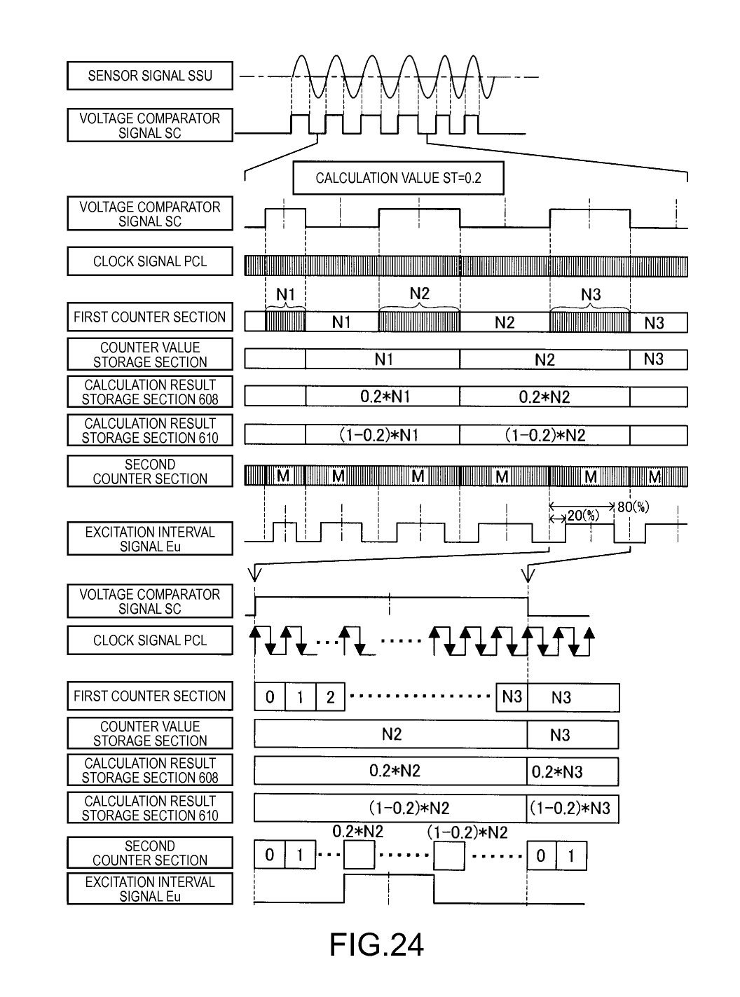

FIG. 24 is a timing chart showing the operation of the excitation interval setting section 590. Firstly, the voltage comparator 585 compares the signal SSU (analog) form the magnetic sensor 300u with a reference signal (not shown) to thereby generate a voltage comparator signal SC as a digital signal. The level of the reference signal is preferably set to the center value of the levels the sensor signal SSU can take. The first counter section 594 counts the number of clock pulses in the period during which the voltage comparator signal SC exhibits a high level based on the clock signal PCL supplied from the control section 592. Specifically, the first counter section 594 starts the count at the timing at which the voltage comparator signal SC is switched from the low level to the high level, and then stores a counter value Ni (i denotes the number of the period) at the timing at which the voltage comparator signal SC exhibits the low level to the counter value storage section 598. Subsequently, the first counter section 594 reset the internal counter value Ni to 0 at the timing at which the voltage comparator signal SC exhibits the high level again in the subsequent period, and then counts again the number of clock pulses in the period during which the voltage comparator signal SC exhibits the high level as a counter value N(i+1). Then, at the timing at which the voltage comparator signal SC exhibits the low level, the first counter section 594 overwrite the counter value storage section 598 with the counter value N(i+1) at that moment.

The first calculation value storage section 600 (FIG. 23) stores a calculation value ST set by the CPU 405. In the example shown in FIGS. 23 and 24, the calculation value ST=0.2 is assumed. The calculation circuit 606 subtracts the calculation value ST stored in the calculation value storage section 600 from 1, and then stores the calculation result (a calculation value ED=1−ST) thus obtained to the second calculation value storage section 602. The first multiplication circuit 604 multiplies the counter value Ni stored in the counter value storage section 598 by the calculation value ST stored in the first calculation value storage section 600, and then stores the calculation result (=Ni×ST) thus obtained to the first calculation result storage section 608. The second multiplication circuit 605 multiplies the counter value Ni stored in the counter value storage section 598 by the calculation value ED stored in the second calculation value storage section 602, and then stores the calculation result (=Ni×ED) thus obtained to the second calculation result storage section 610.

The second counter section 596 starts the count of the number of clock pulses from the timing at which the voltage comparator signal SC exhibits the high level based on the clock signal PCL supplied from the control section 592, and then stops the count at the timing at which it exhibits the low level. Then, the second counter section 596 resets the counter to 0, and at the same time, starts the count of the number of clock pulses from the timing at which the voltage comparator signal SC exhibits the low level, and then stops the count at the timing at which the high level is exhibited. These counter values M are sequentially input to the comparator circuit 612.

The comparator circuit 612 is a window comparator for generating and then outputting the excitation interval signal Eu. Specifically, the comparator circuit 612 compares the calculation result (=Ni×ST) stored in the first calculation result storage section 608 and the second counter values M sequentially input from the second counter section 596 with each other, and then set the excitation interval signal Eu to the high level at the timing at which the values become equal to each other. Subsequently, the comparator circuit 612 compares the calculation result (=Ni×ST) stored in the second calculation result storage section 610 and the second counter values M sequentially input from the second counter section 596 with each other, and then set the excitation interval signal Eu to the low level at the timing at which the values become equal to each other. Also in the period during which the voltage comparator signal SC exhibits the low level, the excitation interval signal Eu is output by substantially the same method as described above.

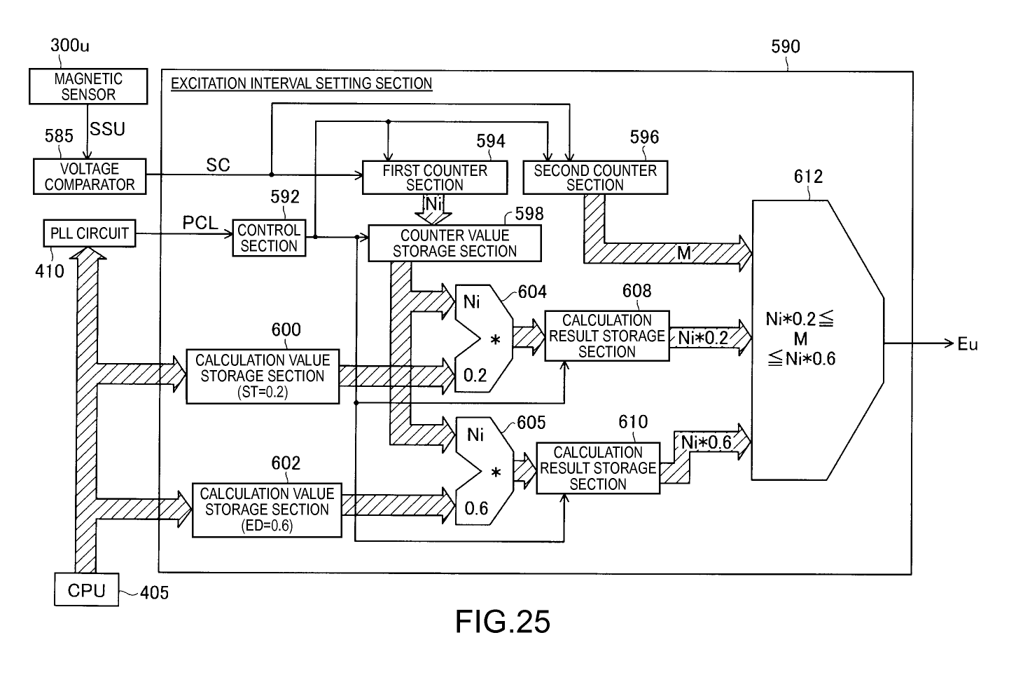

FIG. 25 is an explanatory diagram for explaining how the lead angle is increased. The only difference from the example shown in FIG. 23 is the point that the value of the calculation value ED stored in the calculation value storage section 602 is set as a value independent of the calculation value ST, and other part of the configuration is the same.

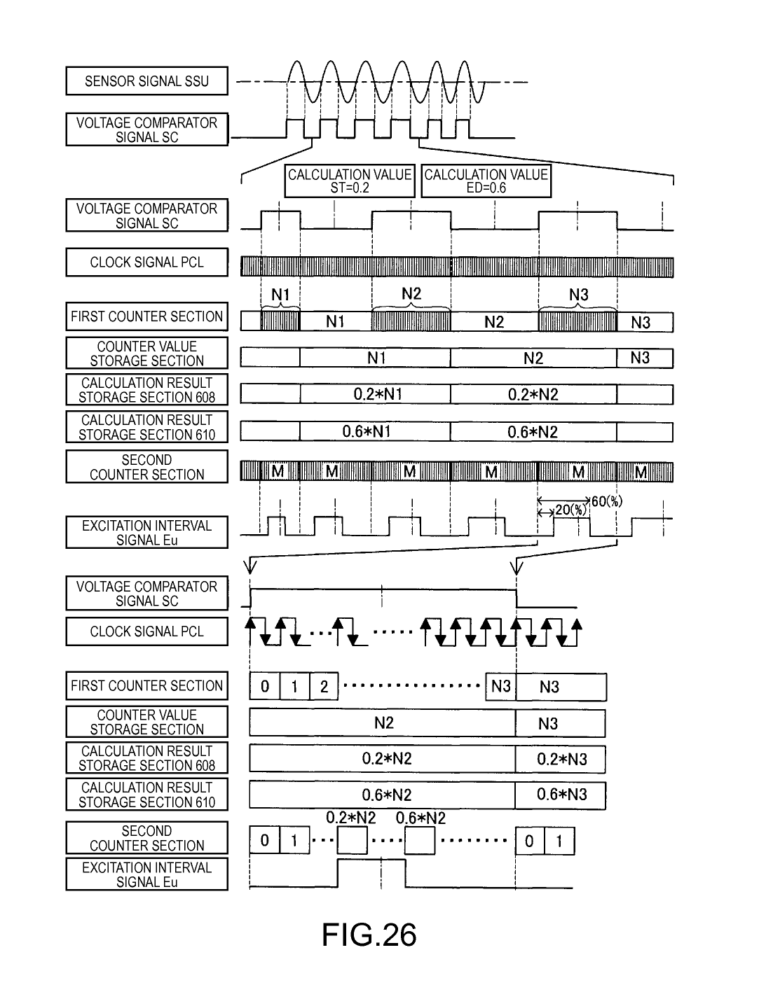

FIG. 26 is a timing chart showing the operation of the excitation interval setting section 590. The only differences from the example shown in FIG. 24 are the point that the calculation value ED is set to 0.6 by the CPU 405, and the point that the center position of the excitation interval EP of the excitation interval signal Eu is shifted to a position earlier than the center position of the high-level signal period of the voltage comparator signal SC due to the fact that the calculation value ED is set to 0.6, and the other operations are the same.

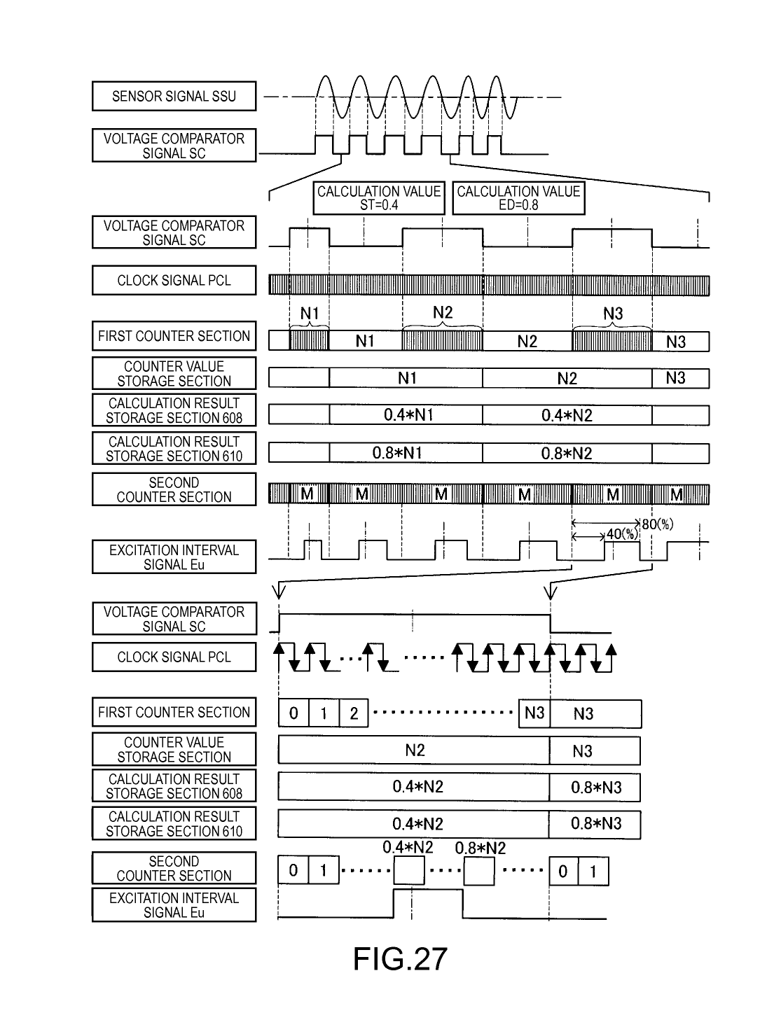

FIG. 27 is a timing chart showing another example of the operation of the excitation interval setting section 590. The only differences from the example shown in FIG. 26 are the point that the calculation value ST is set to 0.4 and the calculation value ED is set to 0.8, and the point that the center position of the excitation interval EP of the excitation interval signal Eu is shifted to a position later than the center position of the high-level signal period of the voltage comparator signal SC, and the other operations are the same as shown in FIG. 26.

As described above, by arbitrarily setting the calculation value ST and the calculation value ED by the CPU 405, it becomes possible to arbitrarily set the phase (the temporal width and the temporal position) of the excitation interval EP. It is preferable for the CPU 405 to refers to the control table 840 based on, for example, the control signals from the torque conversion operation lever 810, the accelerator pedal 820, and the brake pedal 830 to thereby set the calculation value ST and the calculation value ED. According to this operation, the lead angle control of leading the phase of the first and second drive signals DRVA1, DRVA2 can be performed only by leading the temporal position of the excitation interval EP without leading the phase of first and second PWM signals PWM1, PWM2. Further, similarly to the lead angle control, the lag angle control can also be realized.

As described above, according to the present embodiment, the CPU 405 performs the first torque control for setting the excitation interval signals Eu, Ev, and Ew for exciting the magnetic coils 100 around the phase at which the maximum value of the induced voltage caused in the magnetic coils 100 (100u, 100v, and 100w) occurs, and the second torque control for varying the duty ratio of the drive signal for driving the magnetic coils 100. Further, the CPU 405 performs the lead angle control for making the center phase value of the excitation interval signals Eu, Ev, and Ew earlier than the phase value at which the maximum value of the induced voltage caused in the magnetic coils 100 occurs in the first torque control, and varies the duty ratio so that the gain exceeding 100% is obtained assuming that the gain in the sinusoidal wave is 100% in the second torque control. Therefore, the efficient control of the electric motor becomes possible.

In the present embodiment, the shorter the length of the excitation interval signals Eu, Ev, and Ew is, the larger the lead angle in the lead angle control is set. Therefore, the high-speed rotation of the electric motor 10 is possible in the period in which the length of the excitation interval signals Eu, Ev, and Ew is small.

In the present embodiment, since the CPU 405 performs the control of narrowing the excitation interval signals Eu, Ev, and Ew in the first torque control in the case in which the electric motor rotates at high speed, low torque and high rotational frequency can be achieved. Further, since the CPU 405 performs the control of broadening the excitation interval signals Eu, Ev, and Ew in the first torque control in the case of starting the electric motor, starting with high torque can be achieved. Further, since the CPU 405 performs the control of broadening the excitation interval signals Eu, Ev, and Ew in the first torque control in the acceleration operation, acceleration becomes easy due to the high torque. Since the CPU 405 has the control table 840 for performing the control, it becomes possible to easily set the width and the amount of the lead angle of the excitation interval signals Eu, Ev, and Ew.

### Second Embodiment

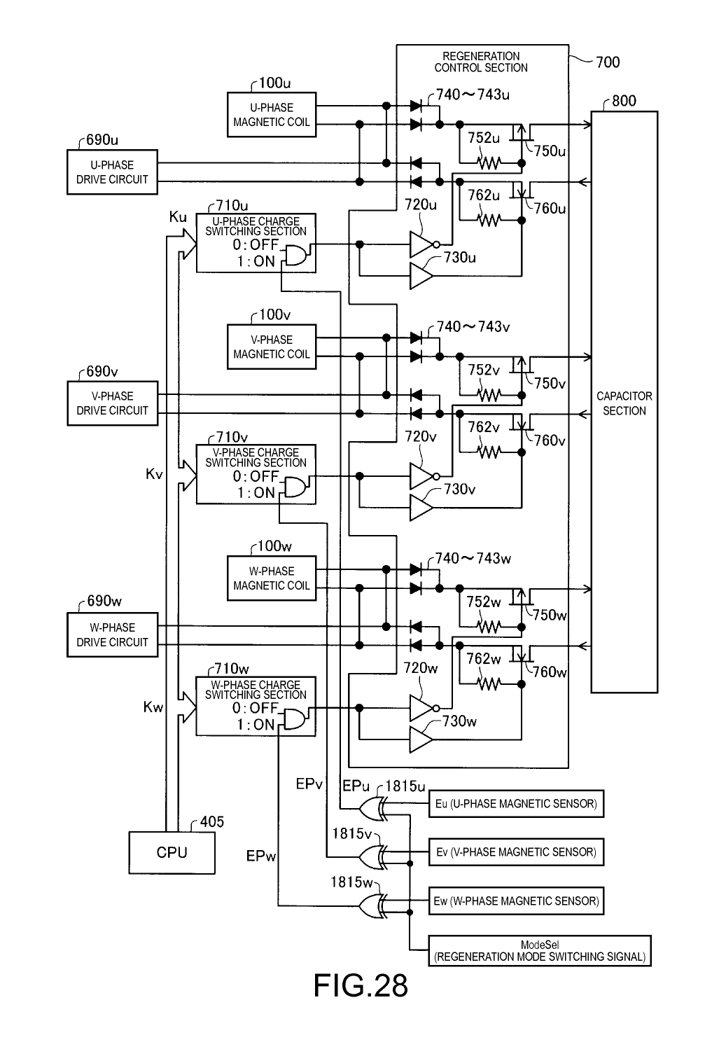

FIG. 28 is an explanatory diagram showing a second embodiment. In the second embodiment regeneration control of the electric motor 10 (not shown) is performed. In the second embodiment, there are provided a regeneration control section 700, a U-phase charge switching section 710u, a V-phase charge switching section 710v, a W-phase charge switching section 710w, a capacitor section 800, and EXOR circuits 1815u, 1815v, and 1815w. The regeneration control section 700 includes a U-phase regeneration control circuit 700u, a V-phase regeneration control circuit 700v, and a W-phase regeneration control circuit 700w. Since the U-phase regeneration control circuit 700u, the V-phase regeneration control circuit 700v, and the W-phase regeneration control circuit 700w have the same configuration, the explanation will be presented citing the U-phase regeneration control circuit 700u as an example. The U-phase regeneration control circuit 700u is connected to the U-phase magnetic coil 100u in parallel to the drive circuit 690u. The U-phase regeneration control section 700u is provided with an inverter circuit 720u, a buffer circuit 730u, a rectifier circuit composed of diodes 740u through 743u, switching transistors 750u, 760u, and resistors 752u, 762u.

In the case in which the excitation interval signal Eu is switched ON, and the brake pedal 830 is trodden, a regeneration signal Ku from the CPU 405 is switched ON, and the U-phase charge switching section 710u is turned ON (=1=H). On this occasion, it is possible to arrange that the stronger the force on the brake pedal 830 is, namely the larger the deceleration is, the longer the ON period of the excitation interval signal Eu is set. If the U-phase charge switching section 710u is turned ON, the output of the inverter circuit 720u is set to the L level, and the switching transistor 750u is set to the ON state. In contrast, since the output of the buffer circuit 730u is set to the H level, the switching transistor 760u is set to the OFF state. In this case, it is possible for the electric motor to regenerate the power generated in the U-phase magnetic coil 100u via the switching transistor 750u to thereby charge the capacitor section 800. In contrast, if the U-phase charge switching section 710u is switched OFF (=0=L), the switching transistor 760u is set to the ON state by the buffer circuit 730u. Meanwhile, the output of the inverter circuit 720u is set to the H level, and the switching transistor 750u is set to the OFF state. On this occasion, it is possible to supply the current from the capacitor section 800 to the U-phase magnetic coil 100u.

There are two regeneration modes, and the switching between the regeneration modes is performed based on a mode switching signal ModeSel. As shown in FIG. 28, an output of the EXOR circuit 1815u having the excitation interval signal Eu (FIG. 13) and the regeneration mode switching signal ModeSel as the input corresponds to a regenerative interval EPu. The CPU 405 generates the regeneration mode switching signal ModeSel to thereby switch the regeneration mode. When the regeneration mode switching signal ModeSel is in the L level, the excitation interval signal Eux and the regenerative interval EPu are in the same logic level. In this case, the CPU 405 flows the regenerative current around the areas with the large induced voltage at the electric angles of π/2, 3π/2. In contrast, when the regeneration mode switching signal ModeSel is in the H level, the logic levels of the excitation interval signal Eu and the regenerative interval EPu are opposite to each other, and the CPU 405 flows the regenerative current centered on the areas with the low induced voltage at the electric angles of 0, π. As described above, it is possible for the CPU 405 to generate the regenerative interval EPu by keeping or inverting the logic level of the excitation interval signal Eu using the mode switching signal ModeSel to thereby switch between the regenerative intervals centered on the electric angles of 0, π, 2π (the zero crossing points of the induced voltage waveform) and the regenerative intervals centered on the electric angles of π/2, 3π/2 (the local maximum points of the induced voltage waveform). Substantially the same applies to the V-phase and the W-phase.

Although in the present embodiment, the CPU 405 switches ON the U-phase charge switching section 710u when the brake pedal 830 is trodden, it is also possible to switch ON the U-phase charge switching section 710u to thereby perform the regenerative braking and the regeneration of the kinetic energy in the case in which the force on the accelerator pedal is reduced to thereby require the engine brake.

It is possible for the CPU 405 to perform the regeneration of the energy while performing the control that the more rapid the deceleration is the broader the excitation interval signal Eu is set in the first torque control to thereby increase the regenerative energy in the deceleration operation of the electric motor, and to perform the control of narrowing the excitation interval signal Eu to thereby prevent occurrence of uncomfortable feeling due to the rapid deceleration in the case in which the deceleration is slow.

### Third Embodiment

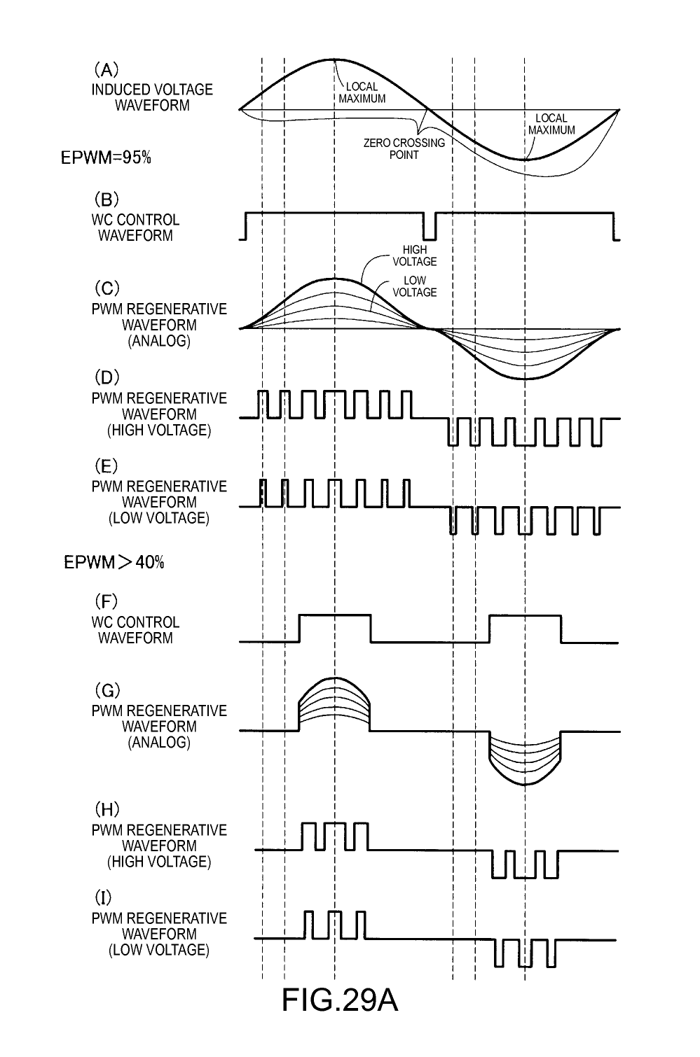

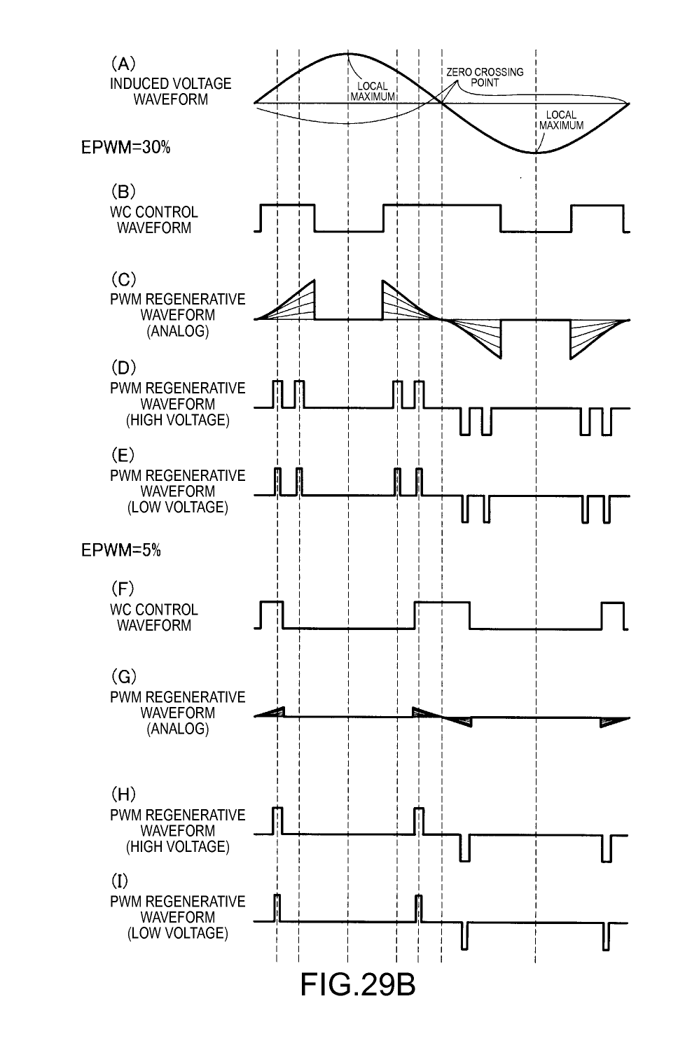

FIGS. 29AA through 29AI are explanatory diagrams showing a regenerative pattern of energy in the case in which the length of an active period of the WC control waveform is long in a third embodiment of the invention. In FIGS. 29AA through 29AI, the value of the EPWM represents the proportion of the active period of the WC control waveform to the electric angle of 2π. In the third embodiment, the CPU 405 (FIG. 12) generates the WC control waveform having the active period centered on the peaks of the induced voltage waveform in the case in which the width of the active period of the WC control waveform is large, or generates the WC control waveform having the active period centered on the zero crossing points of the induced voltage waveform in the case in which the width of the active period of the WC control waveform is small, and thus, regenerates the energy from the magnetic coils 100 (FIG. 1). In the third embodiment, the CPU 405 switches the level of the EPWM and the two regenerative modes in accordance with the force on the brake pedal 830 to perform the regeneration in a variety of regenerative modes. It should be noted that it is possible for the CPU 405 to change the level of the EPWM by changing the value of the electric resistance of the electronic variable resistor 492 of the excitation interval setting section 590 shown in FIG. 17A in accordance with the force on the brake pedal 830.

FIGS. 29AA and 29BA show the induced voltage waveform caused in the magnetic coil 100. It should be noted that the induced voltage waveform does not depend on the value of the EPWM. FIG. 29AB shows the WC control waveform at the EPWM of 95%. In the present embodiment, the regeneration of the energy can be performed in the active period (H) of the WC control waveform. The active period of the WC control waveform is an interval centered on the peak (the local maximum value) of the induced voltage waveform (FIG. 29AA). In the appended claims, this interval is referred to as a “second regenerative interval.” FIG. 29AC shows the PWM regenerative waveform (analog) representing the regenerative energy with analog voltages. In the present embodiment, since the regeneration of the energy is performed using PWM, the regenerative voltage is different if the pulse width is different even if the positions (the phases) of the PWM pulses corresponding to each other are the same. Specifically, the larger the pulse width of each of the PWM pulses is, the higher voltage can be regenerated, and if the pulse width of each of the PWM pulses is smaller, only low voltage can be regenerated. FIGS. 29AD and 29AE show the PWM regenerative waveform (high voltage) as the waveform corresponding to the PWM pulses each having a large pulse width, and the PWM regenerative waveform (low voltage) as the waveform corresponding to the PWM pulses each having a small pulse width, respectively. The waveforms shown in FIGS. 29AD and 29AE are the same in the position (the phase) of the PWM pulses corresponding to each other, but are different in the width of each of the PWM pulses corresponding to each other.

FIGS. 29AF through 29AI show the WC control waveform, the PWM regenerative waveform (analog), the PWM regenerative waveform (high voltage), and the PWM regenerative waveform (low voltage), respectively, in the case in which the EPWM is greater than 40%. As is understood from the comparison between FIGS. 29AD and 29AH, if the active period of the WC control waveform is shortened (the value of the EPWM is reduced), the pulses of the PWM regenerative waveform vanish in the ascending order of the width thereof. In the case in which the PWM pulses vanish in the ascending order of the width in the PWM regenerative waveform as described above, if the thin PWM pulse vanishes, a large variation in the regenerative energy is hard to occur. In other wards, a jerky movement in the operation is hard to occur in the regeneration process.

Here, if the value of the EPWM is further reduced while keeping the active period of the WC control waveform to the interval centered on the peaks (the local maximum values) of the induced voltage waveform (FIG. 29AA), it results that the large PWM pulse in the vicinity of the peak of the induced voltage waveform (FIG. 29AA) vanishes. In such a case, since the significant variation in the regenerative energy occurs, a jerky movement in the operation might occur in the regeneration process.

FIGS. 29BA through 29BI are explanatory diagrams showing a regeneration pattern of energy in the case in which the length of the active period of the WC control waveform is short in the third embodiment. Similarly to FIGS. 29AA through 29AI, in FIGS. 29BA through 29BI, the value of the EPWM represents the proportion of the active period of the WC control waveform to the electric angle of 2π. The induced voltage waveform of FIG. 29BA is the same as the induced voltage waveform of FIG. 29AA. In the present embodiment, if the value of the EPWM is set to a small value, the center of the active period of the WC control waveform is set to the zero crossing points of the induced voltage waveform. Here, the active period of the WC control waveform centered on the zero crossing point is referred to as a “first regenerative interval” in the appended claims.

FIGS. 29BB through 29BE show the WC control waveform, the PWM regenerative waveform (analog), the PWM regenerative waveform (high voltage), and the PWM regenerative waveform (low voltage), respectively, in the case in which the EPWM is equal to 30%. As is understood from the comparison between FIGS. 29AG and 29BC, in the case in which the EPWM is greater than 40%, the PWM regenerative waveform (analog) occurs centered on the peaks of the induced voltage waveform, while in the case in which the EPWM is equal to 30%, the PWM regenerative waveform (analog) occurs centered on the zero crossing points of the induced voltage waveform. Then, as is understood from the comparison between FIGS. 29AH and 29BD, in the case in which the EPWM is greater than 40%, the thin PWM pulses closer to the zero crossing point of the induced voltage waveform vanish, while in the case in which the EPWM is equal to 30%, the thick PWM pulses closer to the center of the peak of the induced voltage waveform vanish.

FIGS. 29BF through 29BI show the WC control waveform, the PWM regenerative waveform (analog), the PWM regenerative waveform (high voltage), and the PWM regenerative waveform (low voltage), respectively, in the case in which the EPWM is equal to 5%. As is understood from the comparison between FIGS. 29BD and 29BH, if the EPWM is reduced from 30% to 5%, the PWM pulse having an intermediate width between the thick PWM pulse closer to the center of the peak of the induced voltage waveform and the thin PWM pulse closer to the zero crossing point of the induced voltage waveform vanishes first.

To summarize the above, in the case in which the EPWM is greater than 40%, the PWM pulses vanish in sequence from the thin PWM pulse closer to the zero crossing points of the induced voltage waveform to the PWM pulse with a roughly intermediate width as the value of the EPWM is reduced. Further, in the case in which the EPWM is equal to 30% or lower than 30%, the PWM pulses vanish in sequence from the PWM pulse with an intermediate size to the thin PWM pulse closer to the zero crossing points of the induced voltage waveform as the value of the EPWM is reduced.

In the present embodiment, since the PWM pulses are vanished in sequence from the thin PWM pulse to the PWM pulse with an intermediate size as the EPWM is reduced as described above, and then, after switching the active center of the WC control waveform, the PWM pulses are vanished in sequence from the PWM pulse with the intermediate size, the variation in the regenerative energy when varying the level of the EPWM can be reduced. As a result, the jerky movement in the regenerative operation can be prevented. It should be noted that substantially the same applies to the case of increasing the EPWM. Specifically, since the PWM pulses are added in sequence from the thin PWM pulse to the PWM pulse with an intermediate size, also in this case, the jerky movement in the regenerative operation can be prevented.

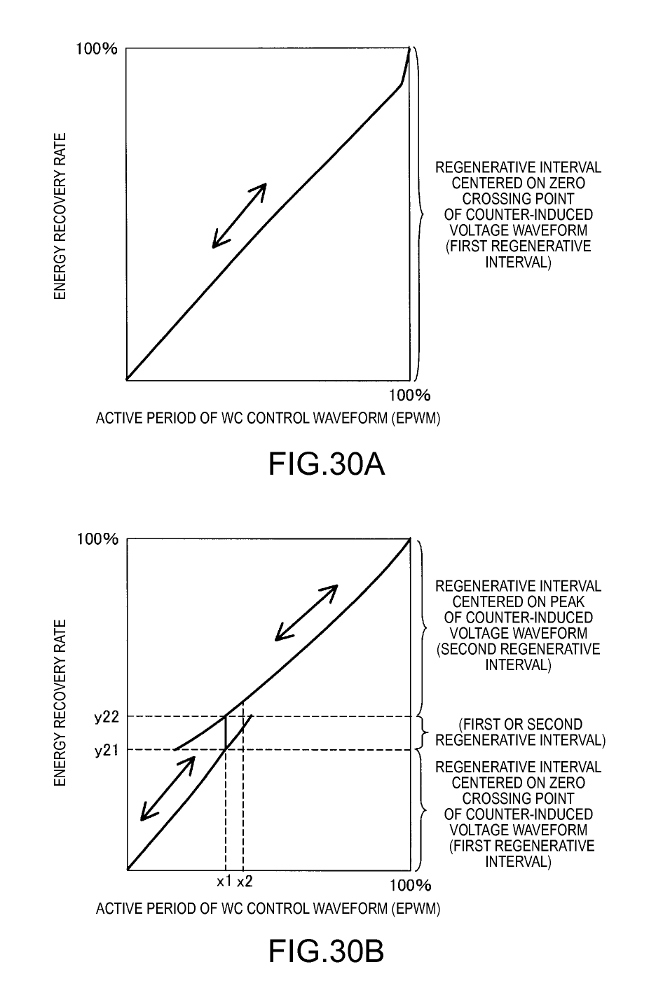

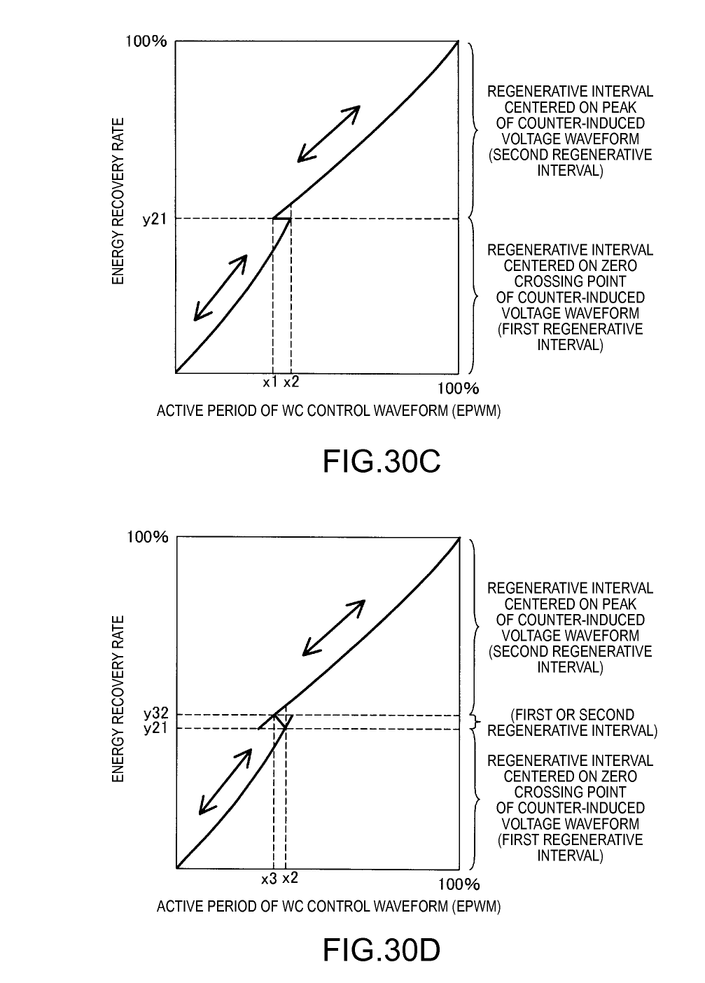

FIGS. 30A through 30D are explanatory diagrams showing variations of the EPWM value and the recovery ratio of the regenerative energy. The example shown in FIG. 30A corresponds to an example in which the CPU 405 forms the entire area of the regeneration period with the active period (the first regenerative interval) of the WC control waveform centered on the zero crossing points. In the case in which the EPWM is equal to 100%, the active period of the WC control waveform centered on the zero crossing points and the active period (the second regenerative interval) centered on the peaks of the induced voltage waveform are identical to each other. According to the present embodiment, if the regenerative energy is small, the variation in the amount of regenerative energy corresponding to the change in the regenerative interval is small, and if the amount of the regenerative energy is large, the variation in the amount of regenerative energy corresponding to the change in the regenerative interval is large. In other words, since the rate (the change rate) of change in the regenerative energy with respect to the amount of regenerative energy can be made roughly constant irrespective of the regenerative intervals, a smooth operation can be achieved in the regeneration process of the electric motor 10.

In the example shown in FIG. 30B, the CPU 405 switches between the first regenerative interval and the second regenerative interval when the value of the EPWM reaches x1. The recovery rate of the regenerative energy when switching is y21 in the first regenerative interval, and is y22 in the second regenerative interval. The change in the regenerative energy when switching is |y21−y22|. If the value of |y21-y22| is small, the jerky movement in the regenerative operation does not occur even if the switching between the first regenerative interval and the second regenerative interval occurs. Further, since the regeneration control section 700 performs the regeneration in the first regenerative interval centered on the zero crossing points of the induced voltage caused in the magnetic coil when the amount of the regenerative energy is small, or performs the regeneration in the second regenerative interval centered on the local maximum points of the induced voltage generated in the magnetic coil when the amount of the regenerative energy is large, the smooth operation can be achieved in the regeneration process of the electric motor 10.

In the example shown in FIG. 30C, the CPU 405 performs switching from the first regenerative interval to the second regenerative interval when the value of the EPWM reaches x2 in the process of increasing the EPWM, and performs switching from the second regenerative interval to the first regenerative interval when the value of the EPWM reaches x1 in the process of decreasing the EPWM. Here, at the point of switching between the first regenerative interval and the second regenerative interval, the recovery rate of the regenerative energy is y21, and therefore, the regenerative energy is continuous. As described above, by providing the continuous regenerative energy, the smoother regeneration can be performed.

Further, according to the example shown in FIG. 30C, since the regeneration control section 700 performs the regeneration in the first regenerative interval centered on the zero crossing points of the induced voltage caused in the magnetic coils 100u, 100v, and 100w when the regeneration period is short and the amount of the regenerative energy is small, or performs the regeneration in the second regenerative interval centered on the local maximum points of the induced voltage generated in the magnetic coils 100u, 100v, and 100w when the regeneration period is long and the amount of the regenerative energy is large, the smooth operation can be achieved in the regeneration process of the electric motor 10. Further, since the regeneration control section 700 performs the switching between the first regeneration mode and the second regeneration mode so that the amount of energy regenerated is the same between before and after the switching, the regenerative energy can be continuous between before and after the switching, and the smooth operation can be achieved in the regenerative operation of the electromechanical device.

The example shown in FIG. 30D is an intermediate example between the example shown in FIG. 30B and the example shown in FIG. 30C. In the example shown in FIG. 30D, the CPU 405 performs switching from the first regenerative interval to the second regenerative interval when the value of the EPWM reaches x2 in the process of increasing the EPWM. The example shown in FIG. 30D is the same as those shown in FIGS. 30B and 30C until this point. In the example shown in FIG. 30B, the CPU 405 raises the recovery rate of the energy from y21 to y22 without changing the level of the EPWM from the x2 when performing the switching from the first regenerative interval to the second regenerative interval. Further, in the example shown in FIG. 30C, the CPU 405 decreases the level of the EPWM from x2 to x1 without changing the recovery rate of the regenerative energy from y21 when performing the switching from the first regenerative interval to the second regenerative interval. In contrast, in the example shown in FIG. 30D, the CPU 405 decreases the level of the EPWM from x2 to x3 (x3>x1), and at the same time, increases the recovery rate of the regenerative energy from y21 to y32 (y32<y22). Even in such a process, the difference in the regenerative energy between the first regenerative interval and the second regenerative interval is small, and therefore, the jerky movement in the regenerative operation can be prevented. It should be noted that in the case of decreasing the value of the EPWM, the CPU 405 performs the switching from the second regenerative interval to the first regenerative interval when the value of the EPWM reaches x3. On this occasion, the new value of the EPWM is set to x2, and the recovery rate of the regenerative energy is decreased from y32 to y21.

According to the example shown in FIG. 30D, since the regeneration is performed in the first regenerative interval centered on the zero crossing points of the induced voltage caused in the magnetic coils 100u, 100v, and 100w when the regeneration period is short and the amount of the regenerative energy is small, or the regeneration is performed in the second regenerative interval centered on the local maximum points of the induced voltage generated in the magnetic coils 100u, 100v, and 100w when the regeneration period is long and the amount of the regenerative energy is large, the smooth operation can be achieved in the regeneration process of the electric motor 10. Further, since when performing the switching from the first regeneration mode to the second regeneration mode, the variation in the regenerative energy between before and after the switching can be reduced, the smooth operation can be achieved in the regeneration process of the electromechanical device.

As shown in FIGS. 30A through 30D, a variety of patterns can be adopted between the EPWM and the recovery rate of the regenerative energy. It should be noted that the switching between the first regenerative interval and the second regenerative interval can be performed using the value of the regeneration mode switching signal ModeSel. In the examples shown in FIGS. 30B and 30D, if the first regenerative interval and the second regenerative interval overlap each other, either one of the first and second regeneration modes, and either one of the first and second regenerative intervals can be used.

Although in the present embodiment, the regeneration of the regenerative energy is considered from the viewpoint of the value of the EPWM, it is also possible to consider the value of the EPWM for performing the switching between the first regenerative interval and the second regenerative interval from the viewpoint of the regenerative energy in an opposite manner. For example, it is possible for the CPU 405 to regenerate the energy in the second regenerative interval if the recovery rate of the regenerative energy is in a range of 100% through 50%, and regenerate the energy in the first regenerative interval if the recovery rate of the regenerative energy is in a range of 50% through 0%.

As shown in the third embodiment, by performing the regeneration of the energy in the first regenerative interval if the value of the EPWM is small or the recovery rate of the regenerative energy is low, and performing the regeneration of the energy in the second regenerative interval if the value of the EPWM is large or the recovery rate of the regenerative energy is high, the jerky movement can be prevented in the regeneration process of the energy. It should be noted that the specific values of the EPWM and the recovery rate of the regenerative energy are illustrative only, and a variety of values can be adopted in an individual electric motor 10 in accordance with the characteristics thereof. Further, it is also possible to perform the regeneration of the energy using the first regenerative interval in the entire interval.

### Modified Examples

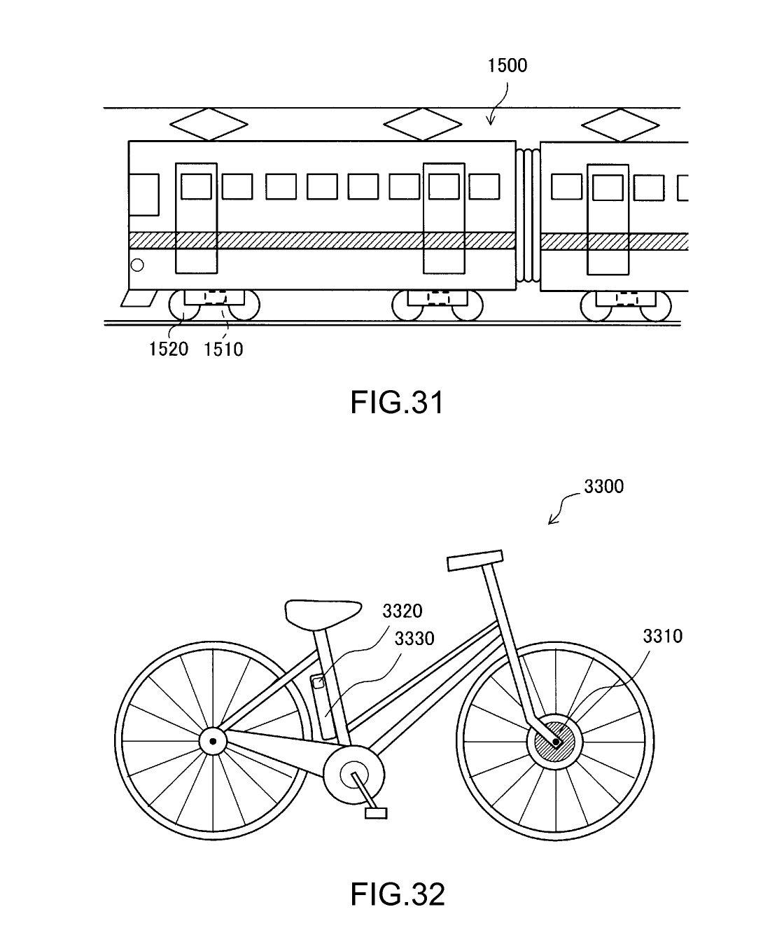

The electric motor according to the invention can also be used as an electric motor for a movable body. FIG. 31 is an explanatory diagram showing a railroad vehicle using an electric motor according to a modified example of the invention. The railroad vehicle 1500 has an electric motor 1510 and wheels 1520. The electric motor 1510 drives the wheels 1520. Further, the electric motor 1510 is used as a generator when breaking the railroad vehicle 1500, and the electric power is regenerated. As the electric motor 1510, various electric motors described above can be used.

FIG. 32 is an explanatory diagram showing an electric bicycle (an electric power-assisted bicycle) as an example of a movable body using a electric motor/generator according to another modified example of the invention. The bicycle 3300 has an electric motor 3310 attached to the front wheel, and a control circuit 3320 and a rechargeable battery 3330 disposed on the frame below a saddle. The electric motor 3310 drives the front wheel using the electric power from the rechargeable battery 3330 to thereby assist running. Further, when breaking, the electric power regenerated by the electric motor 3310 is stored in the rechargeable battery 3330. The control circuit 3320 is a circuit for controlling the drive and regeneration of the electric motor. As the electric motor 3310, various electric motors described above can be used.

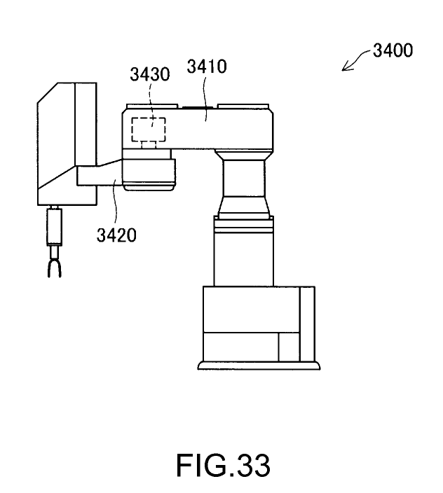

FIG. 33 is an explanatory diagram showing an example of a robot using an electric motor according to another modified example of the invention. The robot 3400 has first and second arms 3410, 3420, and an electric motor 3430. The electric motor 3430 is used when horizontally rotating the second arm 3420 as a driven member. As the electric motor 3430, various electric motors described above can be used.

Although the embodiments of the invention are hereinabove explained based on some specific examples, the embodiments of the invention described above are only for making it easy to understand the invention, but not for limiting the scope of the invention. It is obvious that the invention can be modified or improved without departing from the scope of the invention and the appended claims, and that the invention includes the equivalents thereof.

The present application claims the priority based on Japanese Patent Application No. 2011-031617 filed on Feb. 17, 2011, the disclosure of which is hereby incorporated by reference in its entirety.

What is claimed is:

1. An electromechanical device, comprising:
a first drive member having a magnetic coil;
a second drive member capable of moving relatively to the first drive member; and
a control section adapted to drive the magnetic coil and to perform regeneration of energy from the magnetic coil when decelerating the second drive member,
wherein the control section includes a first regeneration mode of setting a first regenerative interval centered on a zero crossing point of an induced voltage caused in the magnetic coil, and performing the regeneration.

2. The electromechanical device according to claim 1, wherein
the control section further includes a second regeneration mode of setting a second regenerative interval centered on a local maximum point of the induced voltage caused in the magnetic coil, and performing the regeneration, and sets widths of the first and second regenerative intervals so that an amount of energy regenerated in the first regeneration mode is one of equal to and smaller than an amount of energy regenerated in the second regeneration mode.

3. The electromechanical device according to claim 2, wherein
the control section performs the regeneration in the first regeneration mode if a width of one of the first and second regenerative intervals is one of equal to and smaller than a predetermined first value, and performs the regeneration in the second regeneration mode if a width of one of the first and second regenerative intervals is one of equal to and larger than a predetermined second value larger than the first value.

4. The electromechanical device according to claim 3, wherein
the control section performs switching from the second regeneration mode to the first regeneration mode in a process in which an amount of energy regenerated decreases, and sets the width of the first regenerative interval immediately after the switching to be larger than the width of the second regenerative interval immediately before the switching.

5. The electromechanical device according to claim 3, wherein
the control section performs switching from the first regeneration mode to the second regeneration mode in a process in which an amount of energy regenerated increases, and sets the width of the second regenerative interval immediately after the switching to be smaller than the width of the first regenerative interval immediately before the switching.

6. The electromechanical device according to claim 4, wherein
when performing switching between the first regeneration mode and the second regeneration mode, the control section sets the width of one of the first and second regenerative intervals immediately after the switching so that the amount of energy regenerated continuously takes the same value between before and after the switching.

7. A movable body comprising the electromechanical device according to claim 1.

8. A movable body comprising the electromechanical device according to claim 2.

9. A movable body comprising the electromechanical device according to claim 3.

10. A movable body comprising the electromechanical device according to claim 4.

11. A movable body comprising the electromechanical device according to claim 5.

12. A movable body comprising the electromechanical device according to claim 6.

13. A robot comprising the electromechanical device according to claim 1.

14. A robot comprising the electromechanical device according to claim 2.

15. A robot comprising the electromechanical device according to claim 3.

16. A robot comprising the electromechanical device according to claim 4.

17. A robot comprising the electromechanical device according to claim 5.

18. A robot comprising the electromechanical device according to claim 6.
